(19) United States
(12) Patent Application Publication
(10) Pub. No.: US 2025/0045868 A1
(43) Pub. Date: Feb. 6, 2025

(54) EFFICIENT IMAGE-DATA PROCESSING

(71) Applicant: QUALCOMM Incorporated, San Diego, CA (US)

(72) Inventors: Hau HWANG, San Diego, CA (US); Venkata Ravi Kiran DAYANA, San Diego, CA (US)

(21) Appl. No.: 18/364,156

(22) Filed: Aug. 2, 2023

(51) Int. Cl. G06T 3/40; G06T 5/00; G06T 5/20; H04N 25/46

(52) U.S. Cl. CPC G06T 3/4053; G06T 3/4015; G06T 3/4038; G06T 5/20; G06T 5/70; G06T 5/73; H04N 25/46; G06T 2207/20084

(57) ABSTRACT

Systems and techniques are described herein for Processing data. For instance, a method for processing data is provided. The method may include: obtaining image data having a first resolution; downsampling the image data to generate downsampled image data, wherein the downsampled image data has a second resolution that is lower than the first resolution; processing the downsampled image data to generate processed downsampled image data; and generating, using a machine-learning model, upsampled image data based on the processed downsampled image data and the image data.

### TECHNICAL FIELD

The present disclosure generally relates to efficient image-data processing. For example, some aspects of the present disclosure include systems and techniques for downsampling image data, processing the downsampled image data, and upsampling the processed image data. As another example, some aspects of the present disclosure include systems and techniques for receiving first image data and second image data, processing the first image data, and generating processed second image data based on the processed first image data and the second image data.

### BACKGROUND

A camera may focus light onto an image sensor that may generate image data representative of the light. The image data may represent images, such as still images and/or video frames. Image signal processors (ISPs) may receive image data (e.g., raw image data from an image sensor) and process the image data, for example, to perform operations related to, as examples, de-mosaicing, color space conversion, pixel interpolation, automatic exposure control (AEC), automatic gain control (AGC), contrast detect autofocus (CDAF), phase detect autofocus (PDAF), automatic white balance, merging of image frames to form an HDR image, image recognition, object recognition, feature recognition, or some combination thereof. Once processed, the image data may be displayed, stored (e.g., for display at a later time or for use by another system, such as a computer-vision system), and/or transmitted (e.g., for display by another device or for use by another system, such as a computer-vision system).

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described herein for processing data. According to at least one example, an apparatus for processing data is provided. The apparatus includes a memory and one or more processors coupled to the memory. The one or more processors are configured to: obtain image data having a first resolution; downsample the image data to generate downsampled image data, wherein the downsampled image data has a second resolution that is lower than the first resolution; process the downsampled image data to generate processed downsampled image data; and generate, using a machine-learning model, upsampled image data based on the processed downsampled image data and the image data.

In another example, a method for processing data is provided. The method includes: obtaining image data having a first resolution; downsampling the image data to generate downsampled image data, wherein the downsampled image data has a second resolution that is lower than the first resolution; processing the downsampled image data to generate processed downsampled image data; and generating, using a machine-learning model, upsampled image data based on the processed downsampled image data and the image data.

In another example, a non-transitory computer-readable medium is provided that has stored thereon instructions that, when executed by at least one processor, cause the at least one processor to: obtain image data having a first resolution; downsample the image data to generate downsampled image data, wherein the downsampled image data has a second resolution that is lower than the first resolution; process the downsampled image data to generate processed downsampled image data; and generate, using a machine-learning model, upsampled image data based on the processed downsampled image data and the image data.

As another example, an apparatus is provided. The apparatus includes means for obtaining image data having a first resolution; means for downsampling the image data to generate downsampled image data, wherein the downsampled image data has a second resolution that is lower than the first resolution; means for processing the downsampled image data to generate processed downsampled image data; and means for generating, using a machine-learning model, upsampled image data based on the processed downsampled image data and the image data.

As another example, an apparatus for processing data is provided. The apparatus includes a memory and one or more processors coupled to the memory. The one or more processors are configured to: obtain first image data; process the first image data to generate processed first image data; obtain second image data; and generate, using a machine-learning model, processed second image data based on the processed first image data and the second image data.

In another example, a method for processing data is provided. The method includes: obtaining first image data; processing the first image data to generate processed first image data; obtaining second image data; and generating, using a machine-learning model, processed second image data based on the processed first image data and the second image data.

In another example, a non-transitory computer-readable medium is provided that has stored thereon instructions that, when executed by at least one processor, cause the at least one processor to: obtain first image data; process the first image data to generate processed first image data; obtain second image data; and generate, using a machine-learning model, processed second image data based on the processed first image data and the second image data.

As another example, an apparatus is provided. The apparatus includes means for obtaining first image data; means for processing the first image data to generate processed first image data; means for obtaining second image data; and means for generating, using a machine-learning model, processed second image data based on the processed first image data and the second image data.

In some aspects, one or more of the apparatuses described herein is, can be part of, or can include a mobile device (e.g., a mobile telephone or so-called “smart phone”, a tablet computer, or other type of mobile device), an extended reality device (e.g., a virtual reality (VR) device, an augmented reality (AR) device, or a mixed reality (MR) device), a vehicle (or a computing device or system of a vehicle), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a block diagram illustrating an example architecture of an image processing system, according to various aspects of the present disclosure;

FIG. 2A is a diagram illustrating an example system that may efficiently process image data, according to various aspects of the present disclosure;

FIG. 2B is a diagram illustrating examples of downsampling image data, according to various aspects of the present disclosure;

FIG. 2C is a diagram illustrating examples of rearranging image data, according to various aspects of the present disclosure;

FIG. 2D is a diagram illustrating examples of rearranging image data, according to various aspects of the present disclosure;

FIG. 3A is a diagram illustrating an example neural network that may process image data, according to various aspects of the present disclosure;

FIG. 3B is a diagram illustrating an example of rearranging image data, according to various aspects of the present disclosure;

FIG. 4 is a diagram illustrating another example system that may efficiently process image data, according to various aspects of the present disclosure;

FIG. 5 is a diagram illustrating another example neural network that may process image data, according to various aspects of the present disclosure;

FIG. 6A is a diagram illustrating another example system that may efficiently process image data, according to various aspects of the present disclosure;

FIG. 6B is a diagram illustrating another example system that may efficiently process image data, according to various aspects of the present disclosure;

FIG. 7 is a flow diagram illustrating an example process for processing image data, in accordance with aspects of the present disclosure;

FIG. 8 is a flow diagram illustrating another example process for processing image data, in accordance with aspects of the present disclosure;

FIG. 9 is a block diagram illustrating an example of a deep learning neural network that can be used to implement a perception module and/or one or more validation modules, according to some aspects of the disclosed technology;

FIG. 10 is a block diagram illustrating an example of a convolutional neural network (CNN), according to various aspects of the present disclosure; and

FIG. 11 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

An image sensor may capture raw image data. The raw image data may be indicative of intensities of light detected by individual photodetectors of an array of photodetectors of a sensor. In some cases, the array of photodetectors may be coupled to a filter (e.g., a Bayer filter) that may filter out certain wavelengths such that individual photodetectors detect different colors of light. For example, one of every four photodetectors may detect red light, two of every four photodetectors may detect green light, and one of every four photodetectors may detect blue light. The array of photodetectors may include H*W photodetectors, where H is the number of photodetectors along a height dimension of the array and W is the number of photodetectors along a width dimension of the array. The raw image data may include one data point for each photodetector. Thus, the raw image data may include H*W data points.

Some image-processing systems may process raw image data, for example, to perform sensor-related processing (e.g., defect-pixel correction, and demosaicing), lens processing (e.g., shading correction), color correction, tone and gamma processing, noise reduction, sharpening color space conversion, pixel interpolation, automatic exposure control (AEC), automatic gain control (AGC), contrast detect autofocus (CDAF), automatic white balance, merging of image frames to form an HDR image, image recognition, object recognition, feature recognition, or some combination thereof. Some image-processing systems may process the raw image data at full resolution (e.g., processing H*W pixels of the raw image data).

Image processing can be computationally complex or expensive. For example, processing image data can result in large amounts of power consumption, processor usage (which can prevent the processor from performing other tasks, etc. The computational complexity of performing image processing on image data becomes higher as the image data becomes larger. For example, processing raw image data at full resolution may be more computationally expensive than processing the raw image data at a reduced resolution, such as at half resolution (e.g., the raw image data with half of the pixels discarded or ignored). However, in many cases, a processed full-resolution image is desired (e.g., for display) rather than a processed reduced-resolution image (e.g., a half-resolution image).

Systems, apparatuses, methods (also referred to as processes), and computer-readable media (collectively referred to herein as “systems and techniques”) are described herein for efficiently processing image data. In some aspects, the systems and techniques described herein may obtain image data having a first resolution. The systems and techniques can downsample the image data to generate downsampled image data having a second resolution that is lower than the first resolution. The systems and techniques may process the downsampled image data to generate processed downsampled image data and generate, using a machine-learning model, upsampled image data based on the processed downsampled image data and the image data. The machine-learning model may be trained to receive full-resolution image data and processed lower-resolution image data as inputs, and to generate full-resolution image data.

The full-resolution image data is substantially similar to image data that would result from processing the image data at the first resolution (e.g., full resolution), which would require higher image processing complexity. By processing the downsampled image data, the systems and techniques may conserve computational resources (e.g., power and/or processing time) when compared with processing the image data at the first resolution. By upsampling the processed image data, the systems and techniques my generate a version of the image data that has the first resolution (e.g., the original resolution) and that is substantially similar to the image data if it had been processed. In this way, the systems and techniques may conserve computational resources while still generating full-resolution image data that is substantially similar to the image data if it had been processed.

In some aspects, the systems and techniques described herein may obtain first image data and second image data. The first image data and the second image data may be sequential images of a series of images (e.g., frames of video data). The first image data and the second image data may be similar. The systems and techniques may process the first image data to generate processed first image data. The systems and techniques may generate, using a machine-learning model, processed second image data based on the processed first image data and the second image data. The machine-learning model may be trained to receive image data and first processed image data as inputs and to generate second processed image data. For example, the machine-learning model may be trained to generate second image data that is substantially similar to the second image data if the second image data had been processed. By not processing the second image data, the systems and techniques may conserve computational resources when compared with processing the first image data and the second image data. By generating the processed second image data based on the first processed image data and the second image data, the systems and techniques may generate a version of the second image data that is substantially similar to the second image data if it had been processed. In this way, the systems and techniques may conserve computational resources while still generating processed first image data and second image data that is substantially similar to the second image data if it had been processed.

Various aspects of the application will be described with respect to the figures below.

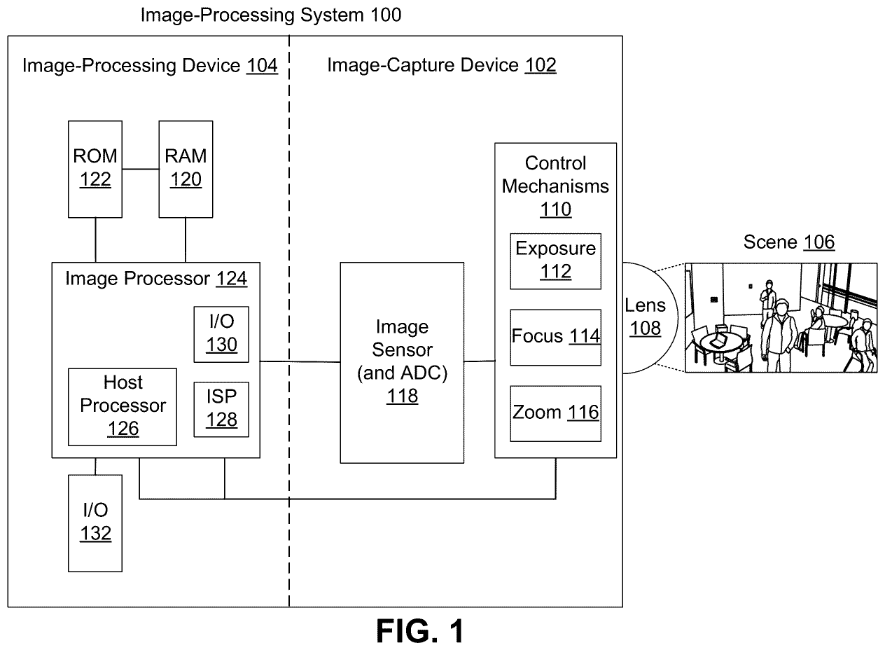

FIG. 1 is a block diagram illustrating an example architecture of an image-processing system 100, according to various aspects of the present disclosure. The image-processing system 100 includes various components that are used to capture and process images, such as an image of a scene 106. The image-processing system 100 can capture image frames (e.g., still images or video frames). In some cases, the lens 108 and image sensor 118 (which may include an analog-to-digital converter (ADC)) can be associated with an optical axis. In one illustrative example, the photosensitive area of the image sensor 118 (e.g., the photodiodes) and the lens 108 can both be centered on the optical axis.

In some examples, the lens 108 of the image-processing system 100 faces a scene 106 and receives light from the scene 106. The lens 108 bends incoming light from the scene toward the image sensor 118. The light received by the lens 108 then passes through an aperture of the image-processing system 100. In some cases, the aperture (e.g., the aperture size) is controlled by one or more control mechanisms 110. In other cases, the aperture can have a fixed size.

The one or more control mechanisms 110 can control exposure, focus, and/or zoom based on information from the image sensor 118 and/or information from the image processor 124. In some cases, the one or more control mechanisms 110 can include multiple mechanisms and components. For example, the control mechanisms 110 can include one or more exposure-control mechanisms 112, one or more focus-control mechanisms 114, and/or one or more zoom-control mechanisms 116. The one or more control mechanisms 110 may also include additional control mechanisms besides those illustrated in FIG. 1. For example, in some cases, the one or more control mechanisms 110 can include control mechanisms for controlling analog gain, flash, HDR, depth of field, and/or other image capture properties.

The focus-control mechanism 114 of the control mechanisms 110 can obtain a focus setting. In some examples, focus-control mechanism 114 stores the focus setting in a memory register. Based on the focus setting, the focus-control mechanism 114 can adjust the position of the lens 108 relative to the position of the image sensor 118. For example, based on the focus setting, the focus-control mechanism 114 can move the lens 108 closer to the image sensor 118 or farther from the image sensor 118 by actuating a motor or servo (or other lens mechanism), thereby adjusting the focus. In some cases, additional lenses may be included in the image-processing system 100. For example, the image-processing system 100 can include one or more microlenses over each photodiode of the image sensor 118. The microlenses can each bend the light received from the lens 108 toward the corresponding photodiode before the light reaches the photodiode.

In some examples, the focus setting may be determined via contrast detection autofocus (CDAF), phase detection autofocus (PDAF), hybrid autofocus (HAF), or some combination thereof. The focus setting may be determined using the control mechanism 110, the image sensor 118, and/or the image processor 124. The focus setting may be referred to as an image capture setting and/or an image processing setting. In some cases, the lens 108 can be fixed relative to the image sensor and the focus-control mechanism 114.

The exposure-control mechanism 112 of the control mechanisms 110 can obtain an exposure setting. In some cases, the exposure-control mechanism 112 stores the exposure setting in a memory register. Based on the exposure setting, the exposure-control mechanism 112 can control a size of the aperture (e.g., aperture size or f/stop), a duration of time for which the aperture is open (e.g., exposure time or shutter speed), a duration of time for which the sensor collects light (e.g., exposure time or electronic shutter speed), a sensitivity of the image sensor 118 (e.g., ISO speed or film speed), analog gain applied by the image sensor 118, or any combination thereof. The exposure setting may be referred to as an image capture setting and/or an image processing setting.

The zoom-control mechanism 116 of the control mechanisms 110 can obtain a zoom setting. In some examples, the zoom-control mechanism 116 stores the zoom setting in a memory register. Based on the zoom setting, the zoom-control mechanism 116 can control a focal length of an assembly of lens elements (lens assembly) that includes the lens 108 and one or more additional lenses. For example, the zoom-control mechanism 116 can control the focal length of the lens assembly by actuating one or more motors or servos (or other lens mechanism) to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 108 in some cases) that receives the light from the scene 106 first, with the light then passing through a focal zoom system between the focusing lens (e.g., lens 108) and the image sensor 118 before the light reaches the image sensor 118. The focal zoom system may, in some cases, include two positive (e.g., converging, convex) lenses of equal or similar focal length (e.g., within a threshold difference of one another) with a negative (e.g., diverging, concave) lens between them. In some cases, the zoom-control mechanism 116 moves one or more of the lenses in the focal zoom system, such as the negative lens and one or both of the positive lenses. In some cases, zoom-control mechanism 116 can control the zoom by capturing an image from an image sensor of a plurality of image sensors (e.g., including image sensor 118) with a zoom corresponding to the zoom setting. For example, the image-processing system 100 can include a wide-angle image sensor with a relatively low zoom and a telephoto image sensor with a greater zoom. In some cases, based on the selected zoom setting, the zoom-control mechanism 116 can capture images from a corresponding sensor.

The image sensor 118 includes one or more arrays of photodiodes or other photosensitive elements. Each photodiode measures an amount of light that eventually corresponds to a particular pixel in the image produced by the image sensor 118. In some cases, different photodiodes may be covered by different filters. In some cases, different photodiodes can be covered in color filters, and may thus measure light matching the color of the filter covering the photodiode. Various color filter arrays can be used such as, for example and without limitation, a Bayer color filter array, a quad color filter array (QCFA), and/or any other color filter array.

In some cases, the image sensor 118 may alternately or additionally include opaque and/or reflective masks that block light from reaching certain photodiodes, or portions of certain photodiodes, at certain times and/or from certain angles. In some cases, opaque and/or reflective masks may be used for phase detection autofocus (PDAF). In some cases, the opaque and/or reflective masks may be used to block portions of the electromagnetic spectrum from reaching the photodiodes of the image sensor (e.g., an IR cut filter, a UV cut filter, a band-pass filter, low-pass filter, high-pass filter, or the like). The image sensor 118 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 110 may be included instead or additionally in the image sensor 118. The image sensor 118 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

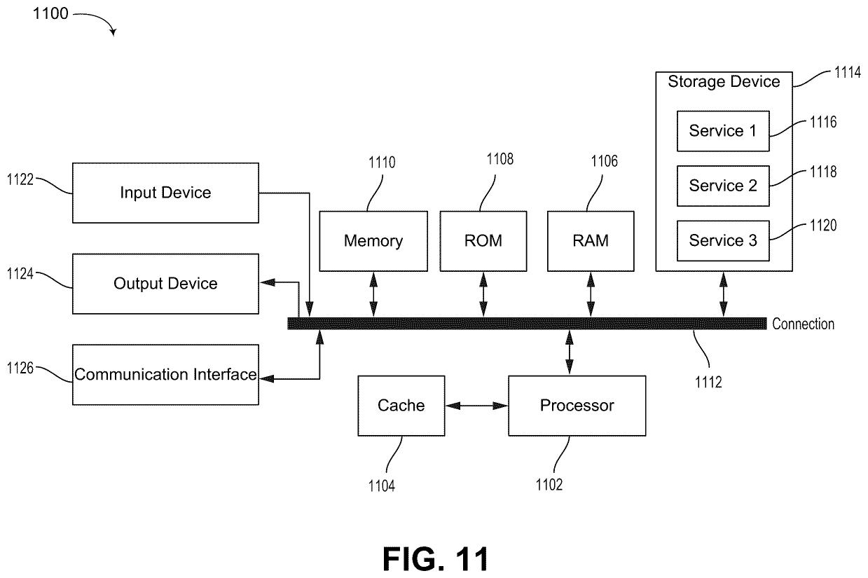

The image processor 124 may include one or more processors, such as one or more image signal processors (ISPs) (including ISP 128), one or more host processors (including host processor 126), and/or one or more of any other type of processor discussed with respect to the computing-device architecture 1100 of FIG. 11. The host processor 126 can be a digital signal processor (DSP) and/or other type of processor. In some implementations, the image processor 124 is a single integrated circuit or chip (e.g., referred to as a system-on-chip or SoC) that includes the host processor 126 and the ISP 128. In some cases, the chip can also include one or more input/output ports (e.g., input/output (I/O) ports 130), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 130 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General-Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 126 can communicate with the image sensor 118 using an I2C port, and the ISP 128 can communicate with the image sensor 118 using an MIPI port.

The image processor 124 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 124 may store image frames and/or processed images in random-access memory (RAM) 120, read-only memory (ROM) 122, a cache, a memory unit, another storage device, or some combination thereof.

Various input/output (I/O) devices 132 may be connected to the image processor 124. The I/O devices 132 can include a display screen, a keyboard, a keypad, a touchscreen, a trackpad, a touch-sensitive surface, a printer, any other output devices, any other input devices, or any combination thereof. In some cases, a caption may be input into the image-processing device 104 through a physical keyboard or keypad of the I/O devices 132, or through a virtual keyboard or keypad of a touchscreen of the I/O devices 132. The I/O devices 132 may include one or more ports, jacks, or other connectors that enable a wired connection between the image-processing system 100 and one or more peripheral devices, over which the image-processing system 100 may receive data from the one or more peripheral device and/or transmit data to the one or more peripheral devices. The I/O devices 132 may include one or more wireless transceivers that enable a wireless connection between the image-processing system 100 and one or more peripheral devices, over which the image-processing system 100 may receive data from the one or more peripheral device and/or transmit data to the one or more peripheral devices. The peripheral devices may include any of the previously-discussed types of the I/O devices 132 and may themselves be considered I/O devices 132 once they are coupled to the ports, jacks, wireless transceivers, or other wired and/or wireless connectors.

In some cases, the image-processing system 100 may be a single device. In some cases, the image-processing system 100 may be two or more separate devices, including an image-capture device 102 (e.g., a camera) and an image-processing device 104 (e.g., a computing device coupled to the camera). In some implementations, the image-capture device 102 and the image-capture device 102 may be coupled together, for example via one or more wires, cables, or other electrical connectors, and/or wirelessly via one or more wireless transceivers. In some implementations, the image-capture device 102 and the image-processing device 104 may be disconnected from one another.

As shown in FIG. 1, a vertical dashed line divides the image-processing system 100 of FIG. 1 into two portions that represent the image-capture device 102 and the image-processing device 104, respectively. The image-capture device 102 includes the lens 108, control mechanisms 110, and the image sensor 118. The image-processing device 104 includes the image processor 124 (including the ISP 128 and the host processor 126), the RAM 120, the ROM 122, and the I/O device 132. In some cases, certain components illustrated in the image-capture device 102, such as the ISP 128 and/or the host processor 126, may be included in the image-capture device 102. In some examples, the image-processing system 100 can include one or more wireless transceivers for wireless communications, such as cellular network communications, 802.11 wi-fi communications, wireless local area network (WLAN) communications, or some combination thereof.

The image-processing system 100 can be part of, or implemented by, a single computing device or multiple computing devices. In some examples, the image-processing system 100 can be part of an electronic device (or devices) such as a camera system (e.g., a digital camera, an IP camera, a video camera, a security camera, etc.), a telephone system (e.g., a smartphone, a cellular telephone, a conferencing system, etc.), a laptop or notebook computer, a tablet computer, a set-top box, a smart television, a display device, a game console, an XR device (e.g., an HMD, smart glasses, etc.), an IoT (Internet-of-Things) device, a smart wearable device, a video streaming device, an Internet Protocol (IP) camera, or any other suitable electronic device(s).

While the image-processing system 100 is shown to include certain components, one of ordinary skill will appreciate that the image-processing system 100 can include more components than those shown in FIG. 1. The components of the image-processing system 100 can include software, hardware, or one or more combinations of software and hardware. For example, in some implementations, the components of the image-processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image-processing system 100.

In some examples, the computing-device architecture 1100 shown in FIG. 11 and further described below can include the image-processing system 100, the image-capture device 102, the image-processing device 104, or a combination thereof.

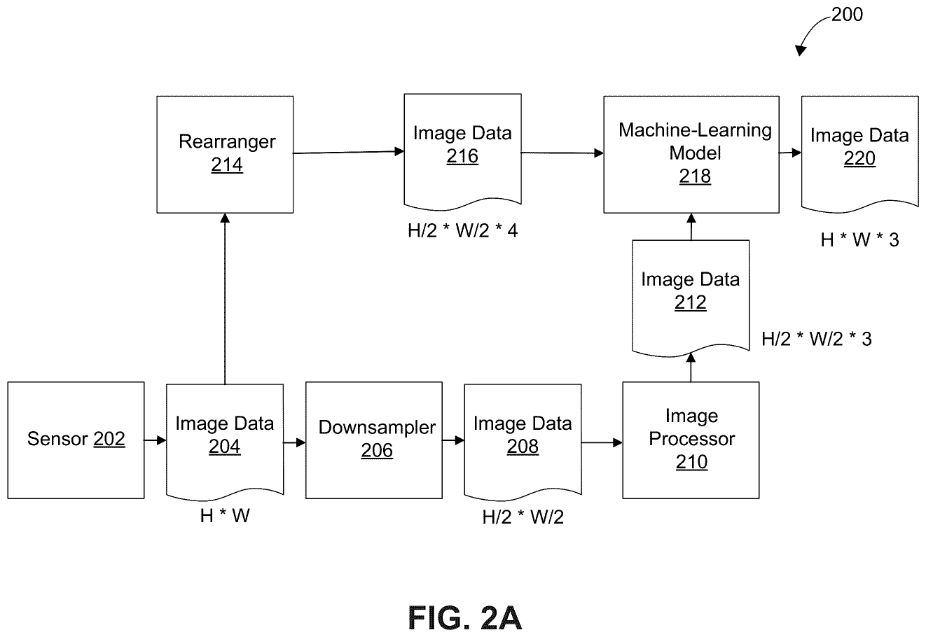

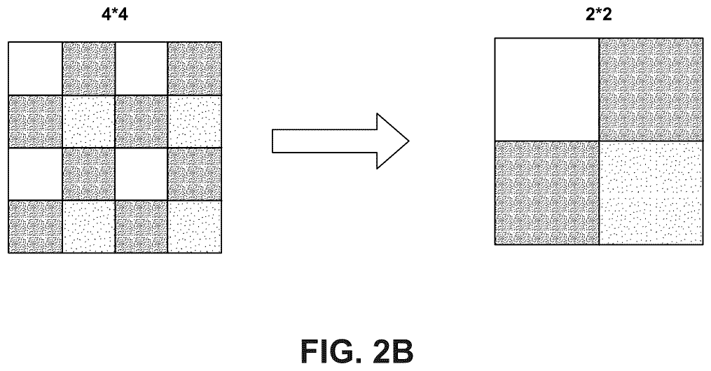

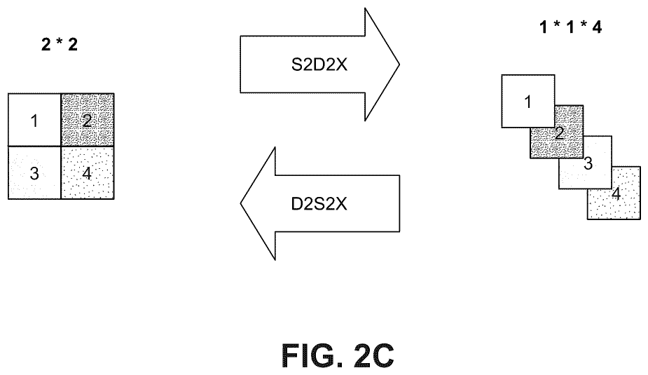

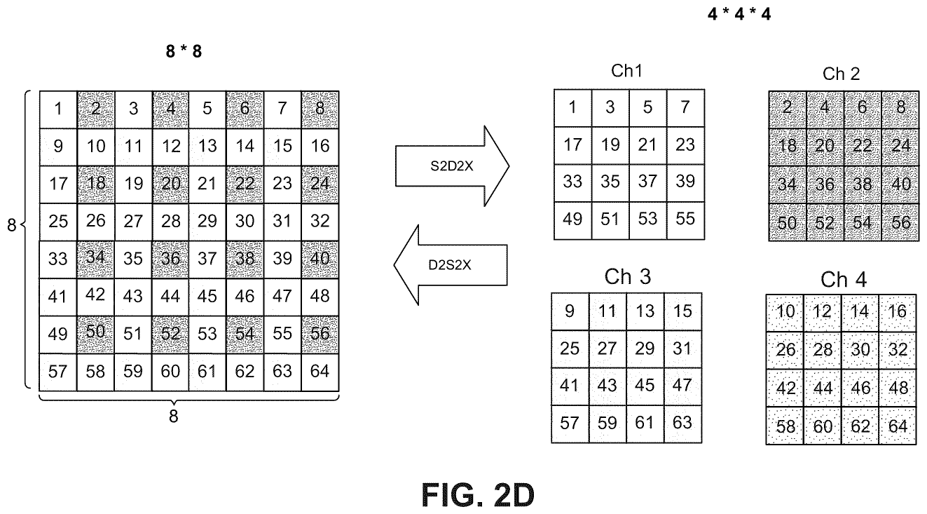

FIG. 2A is a diagram illustrating an example system 200 that may efficiently process image data 204, according to various aspects of the present disclosure. For example, system 200 may receive image data 204 from a sensor 202. System 200 may include a downsampler 206 that may downsample image data 204 to generate image data 208, an image processor 210 that may process image data 208 to generate image data 212, a rearranger 214 that may rearrange image data 204 to generate image data 216, and a machine-learning model 218 that generate image data 220 based on image data 212 and image data 216.

Sensor 202 may be an example of image sensor 118 of FIG. 1 or an example of image-capture device 102 of FIG. 1. System 200 may include sensor 202. Alternatively, sensor 202 may not be a part of system 200 and yet sensor 202 may provide image data 204 to system 200. Sensor 202 may include an array of photodetectors and may generate image data 204 based on light impinging on the array of photodetectors. Image data 204 may be indicative of intensities of light detected by individual photodetectors of an array of photodetectors of sensor 202. The array of photodetectors of sensor 202 may include H*W photodetectors, where H is the number of photodetectors along a height dimension of the array and W is the number of photodetectors along a width dimension of the array. The image data 204 may include one data point for each photodetector of the array. As such, image data 204 may include H*W data points (which may be pixels). In some cases, the array of photodetectors may be coupled to a filter (e.g., a Bayer filter) that may filter out certain wavelengths such that individual photodetectors detect different colors of light. For example, one of every four photodetectors may detect red light, two of every four photodetectors may detect green light, and one of every four photodetectors may detect blue light. As such, one out of every four data points of image data 204 may represent an intensity of red light, two out of every four data points of image data 204 may represent an intensity of green light, and one out of every four data points of image data 204 may represent an intensity of blue light.

Downsampler 206 may be implemented in image processor 124 of FIG. 1, or in another processor or circuit of image-processing device 104. Downsampler 206 may downsample image data 204 to generate image data 208 (which may be downsampled image data). As an example, FIG. 2B is a diagram illustrating an example of downsampling data, according to various aspects of the present disclosure. The example of FIG. 2B illustrates downsampling 4*4 image data to generate 2*2 image data. Returning to FIG. 2A, image data 204 may have H*W data points (e.g., arranged in an H*W grid). As such, image data 204 may be full-resolution image data. Downsampler 206 may downsample image data 204 to obtain image data 208 which may include fewer data points than image data 204. For instance, downsampler 206 may bin (in horizontal and vertical directions) image data 204 by a factor of 2 to generate image data 208 with H/2*W/2 data points. As such, image data 208 may be quarter-resolution image data (e.g., representing the same light intensities as image data 204, but at one quarter the resolution). Downsampler 206 may take the Bayer pattern into account by, for example, binning a group of four pixels with an adjacent group of four pixels. As a result, image data 208 may still include data according to the Bayer pattern. Binning by a factor of 2 is given as an example. Other factors and downsampling techniques are within the scope of this disclosure.

Image processor 210 may be implemented in, or be an example of, image processor 124 of FIG. 1. Image processor 210 may process image data 208 to generate image data 212 (which may be processed image data). Image processor 210 may perform a number of tasks, such as sensor-related processing (e.g., defect-pixel correction, and demosaicing), lens processing (e.g., shading correction), color correction, tone and gamma processing, noise reduction, sharpening color space conversion, pixel interpolation, automatic exposure control (AEC), automatic gain control (AGC), contrast detect autofocus (CDAF), automatic white balance, merging of image frames to form an HDR image, image recognition, object recognition, feature recognition, or some combination thereof. Among other things, image processor 210 may de-mosaic image data 208 when generating image data 212 such that image data 212 includes data in a red-green-blue (RGB) format. As such image data 212 may include three data points (e.g., representing an intensity of red light, an intensity of green light, and an intensity of blue light) for each data point of image data 208. Accordingly, in cases where image data 208 has been downsampled by a factor of 2 (to have H/2*W/2 data points) image data 212 may include H/2*W/2*3 data points. The H/2*W/2*3 data points may be arranged in as a three-dimensional tensor having dimensions of H/2*W/2*3.

Rearranger 214 may be implemented in image processor 124 or in another processor or circuit of image-processing device 104. Rearranger 214 may rearrange local groups of pixels image data 204 to generate image data 216 (which may be rearranged image data). Rearranging image data may include changing dimensions of the images data without losing image data. As examples, FIG. 2C and FIG. 2D are diagrams illustrating examples of rearranging image data, according to various aspects of the present disclosure. FIG. 2C illustrates a S2D 2× rearranging going left to right (e.g. transforming 2*2 image data on the left into 1*1*4 image data on the right) and a depth to space (D2S) 2× rearranging going right to left (e.g. transforming the 1*1*4 image data on the right into the 2*2 image data on the left). FIG. 2D illustrates a S2D 2× rearranging going left to right (e.g. transforming 8*8 image data on the left into 4*4*4 image data on the right) and a depth to space (D2S) 2× rearranging going right to left (e.g. transforming the 4*4*4 image data on the right into the 8*8 image data on the left). Returning to FIG. 2A, as mentioned previously, image data 204 may have H*W data points (e.g., arrange in a two-dimensional grid). Further, one of every four data points may represent an intensity of red light, two of every four data points may represent an intensity of green light, and one of every four data points may represent an intensity of blue light. Rearranger 214 may rearrange image data 204 by arranging data points representing red light into a group or two-dimensional grid, data points representing green light into two groups or two-dimensional grids, and data points representing blue light into a group or two-dimensional grid. As a result, image data 216 may include four groups or two-dimensions girds each having the dimension of H/2*W/2. The four H/2*W/2 two-dimensional grids of image data 216 may be arranged in a three-dimensional tensor having dimensions of H/2*W/2*4. Rearranger 214 may implement what may be referred to in the art as a space-to-depth (S2D) transform.

Machine-learning model 218 may be implemented in image processor 124 or in another processor of image-processing device 104. Machine-learning model 218 may be trained to receive full-resolution image data and processed lower-resolution image data as inputs and to generate processed full-resolution image data. For example, machine-learning model 218 may be trained using a back-propagation training technique by receiving full-resolution image data (e.g., an original image) and processed lower-resolution image data (e.g., the original image downsampled, then processed) as inputs. Machine-learning model 218 may then generate full-resolution image data as an output. Separately, the original image data may be processed and the processed original image data may be compared to the output of machine-learning model 218 to determine a loss based on differences between the processed original image data and the output of machine-learning model 218. Machine-learning model 218 may be adjusted (e.g., weights or parameters of machine-learning model 218 may be adjusted) to decrease the loss in further iterations of the training process. The back-propagation process may be repeated any number of times to train machine-learning model 218.

At inference (e.g., after training), machine-learning model 218 may receive image data 212 (which may be a tensor having dimensions of H/2*W/2*3) and image data 216 (which may be a tensor having dimensions of H/2*W/2*4) as inputs. In some cases, image data 212 and image data 216 may be concatenated together to form a single tensor having dimensions of H/2*W/2*7. Machine-learning model 218 may include one or more convolutional layers. The convolutional layers may be sized to operate according to the dimensions of the single tensor (H/2*W/2*7). Based on image data 212 and image data 216, machine-learning model 218 may generate image data 220. Image data 220 may have dimensions of H*W (e.g., image data 220 may be full-resolution image data). Image data 220 may be substantially similar to image data that would result from processing image data 204 using image processor 210. For example, image data 220 may approximate the result of processing image data 204 with image processor 210. However, because, in system 200, image processor 210 operates on image data 208 (which is one fourth the size of image data 204), system 200 conserves computational resources (processing time and power) when compared with a system that processes image data 204 using image processor 210.

Image data 220 may be displayed (e.g., at a display of a system or device including system 200 or by another system or device). For example, image data 220 may be displayed at a display of a smart phone that includes system 200, at a display of an extended reality (XR) system that includes system 200, on a display (e.g., a computer or television display) after being generated by a system 200 in a separate system or device. Additionally, or alternatively, image data 220 may be stored (e.g., in a memory of a system or device including system 200). For example, image data 220 may be stored in a memory by a camera including system 200. At a later time, image data 220 may be displayed or provided to another system or device (e.g., for display or analysis by the other system or device). Additionally, or alternatively, image data 220 may be transmitted (e.g., from a system or device including system 200 to another system or device). For example, a camera may generate image data 220 and may transmit image data 220 to another system or device (e.g., for display or analysis). In some aspects, image data 220 may be analyzed (e.g., by a machine-learning model without being displayed. For example, image data 220 may be used in by an object tracking algorithm.

System 200 is illustrated and described as downsampling image data 204 at downsampler 206 and upsampling image data 212 at machine-learning model 218 by a factor of 2 as an example. In other aspects, system 200 may downsample and upsample image data by other factors, for example, 1.5, 3, 4, etc.

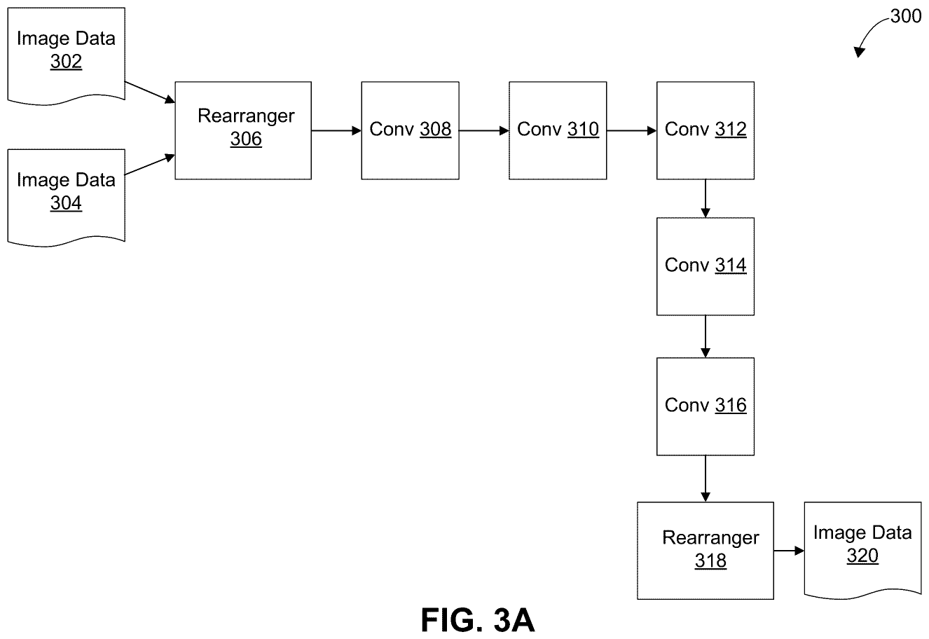

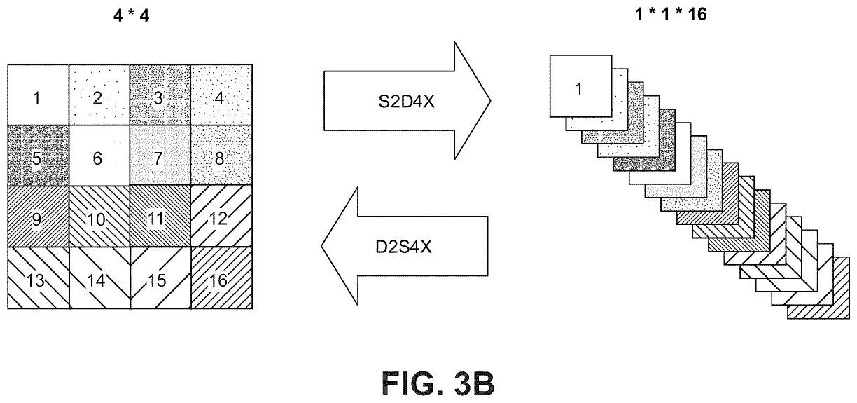

FIG. 3A is a diagram illustrating an example neural network 300 that may process image data 302 and image data 304, according to various aspects of the present disclosure. Neural network 300 may be an example of machine-learning model 218 of FIG. 2A. Neural network 300 may receive image data 302 and image data 304 as inputs, rearrange image data 302 and image data 304 and provide the rearranged image data to a number of convolutional layers (e.g., a convolutional layer 308, a convolutional layer 310, a convolutional layer 312, a convolutional layer 314, and a convolutional layer 316), then to a rearranger 318 which may rearrange the image data to generate image data 320.

Image data 302 may be processed downsampled image data. For example, image data 302 may be an example of image data 212 of FIG. 2A. For instance, an original image may be a full-resolution image data having H*W data points where H relates to a height dimension and W relates to a width dimension. The original image may be downsampled (e.g., by horizontal and vertical binning by a factor of two) (e.g., as illustrated and described with regard to FIG. 2B). The downsampled image data may have H/2*W/2 data points. The downsampled image data may be processed (e.g., a processor that is the same as, or substantially similar to, and/or performs the same, or substantially the same, operations as image processor 210 of FIG. 2A). Image data 302 may be the resulting processed downsampled image data. The processing may include de-mosaicing which may cause image data 302 to be in an RGB format. Image data 302 may be arranged as a tensor having dimensions of H/2*W/2*3.

Image data 304 may be rearranged image data. For example, image data 304 may be an example of image data 216 of FIG. 2A. For instance, the original image data (from which image data 302 is derived) may be rearranged to generate image data 304 (e.g., as illustrated and described with regard to FIG. 2C and FIG. 2D). For example, the original image data may have dimensions of H*W and may be according to a Bayer pattern (e.g., with one of every four data points representing an intensity of red light, with two of every four data points representing an intensity of green light, and with one of every four data points representing an intensity of blue light). The original data may be rearranged into a tensor such that the colors are a dimension. For example, the data points representing red light may be arranged into a two-dimensional grid, the data points representing green light may be arranged into two two-dimensional grids, and the data points representing blue light may be arranged into a two-dimensional grid. The two-dimensional grids may be stacked to form a tensor having dimensions of H/2*W/2*4.

Rearranger 306 may receive image data 302 and image data 304 as inputs. Rearranger 306 may combine (e.g., concatenate) image data 302 and image data 304 to form a single tensor having dimensions of H/2*W/2*7. Rearranger 306 may rearrange the tensor by selecting one of every four data points of each two-dimensional grid layer to form a new two-dimensional grid layer. For example, the H/2*W/2 two-dimensional grid of data points representing red light may become a four H/4*W/4 two-dimensional grids that may be arranged as a tensor having dimensions H/4*W/4*4. In this way, the H/2*W/2*7 tensor may be rearranged into a H/4*W/4*28 tensor. Rearranger 306 may implement a space-to-depth (S2D) transform. The rearranging of the H/2*W/2*7 tensor to generate the H/4*W/4*28 tensor may be analogous to the left-to-right S2D rearranging illustrated and described with regard to FIG. 2C and FIG. 2D, however the dimensions (e.g., the starting dimensions and ending dimensions) may be different.

Convolutional layer 308 may receive the H/4*W/4*28 tensor from rearranger 306. Convolutional layer 308 may convolve the H/4*W/4*28 tensor with a kernel (e.g., a 3*3 kernel). Further, convolutional layer 308 may include a linear unit (e.g., rectified linear unit (ReLU) or a parametric rectified linear unit (PRELU).

Each of convolutional layer 310, convolutional layer 312, convolutional layer 314, and convolutional layer 316 may receive and convolve the tensor in turn. For example, each of convolutional layer 310, convolutional layer 312, convolutional layer 314, may include a respective kernel (e.g., a 3*3 kernel or a 1*1 kernel) with which convolutional layer 310, convolutional layer 312, and convolutional layer 314 may in turn respectively convolve the tensor. Further, each of convolutional layer 310, convolutional layer 312, convolutional layer 314, and convolutional layer 316 may include a respective linear unit (e.g., a ReLU or a PRELU). Convolutional layer 310 may receive the H/4*W/4*64 tensor output by convolutional layer 308, convolve the H/4*W/4*64 tensor (e.g., using a 3*3 kernel), and output a H/4*W/4*64 tensor (having substantially the same dimensions as the tensor received by convolutional layer 310, based on ignoring any decrease in size due to convolution) to convolutional layer 312. Similarly, convolutional layer 312 may receive the H/4*W/4*64 tensor output by convolutional layer 310, convolve the H/4*W/4*64 tensor (e.g., using a 3*3 kernel), and output a H/4*W/4*64 tensor (ignoring any decrease in size due to convolution) to convolutional layer 314. Similarly, convolutional layer 314 may receive the H/4*W/4*64 tensor output by convolutional layer 312, convolve the H/4*W/4*64 tensor (e.g., using a 3*3 kernel), and output a H/4*W/4*64 tensor (ignoring any decrease in size due to convolution) to convolutional layer 316. Convolutional layer 316 may receive the H/4*W/4*64 tensor output by convolutional layer 314, convolve the H/4*W/4*64 tensor (e.g., using a 1*1 kernel), and output a H/4*W/4*48 tensor to rearranger 318.

Rearranger 318 may receive the H/4*W/4*48 tensor from convolutional layer 316 and rearranged the H/4*W/4*48 tensor into image data 320. Rearranger 318 may rearrange the H/4*W/4*48 tensor into a H*W*3 tensor (e.g., by combining four H/4*W/4 two-dimensional grids into one H*W two-dimensional grid). Rearranger 318 may implement what may be referred to in the art as a depth-to-space (D2S) transform. The rearranging of the H/4*W/4*48 tensor to generate the H*W*3 tensor may be analogous to the right-to-left D2S rearranging illustrated and described with regard to FIG. 2C and FIG. 2D, however the dimensions (e.g., the starting dimensions and ending dimensions) and the scale of the rearranging may be different (e.g., FIG. 2C and FIG. 2D illustrate 2× scaling whereas rearranger 318 performs a 4× scaling). FIG. 3B is a diagram illustrating an example of rearranging image data, according to various aspects of the present disclosure. For example, FIG. 3B illustrates a S2D 4×rearranging going left to right (e.g. transforming 4*4 image data on the left into 1*1*16 image data on the right) and a D2S 4× rearranging going right to left (e.g. transforming the 1*1*16 image data on the right into the 4*4 image data on the left). Returning to FIG. 3A, each of the H*W two-dimensional grids may represent a color (e.g., red, green, and blue). Accordingly, the H*W*3 tensor of image data 320 may represent an image in an RGB format. Accordingly, image data 320 may be full-resolution image data in RGB format.

Neural network 300 is illustrated and described as upsampling image data 302 by a factor of 2 as an example. In other aspects, neural network 300 may upsample image data by other factors, for example, 1.5, 3, 4, etc.

As described above with regard to FIG. 2A, system 200 may efficiently process image data 204 by decreasing the size of image data 204 to generate image data 208 then processing image data 208 using image processor 210. Processing image data 208 at image processor 210 rather than image data 204 may conserve computational resources compared with processing image data 204 at image processor 210. Further, system 200 may use machine-learning model 218 (of which neural network 300 of FIG. 3A may be an example) to generate image data 220 which may be substantially similar to the result of processing image data 204 at image processor 210. In this way, system 200 may conserve computational resources, compared with processing image data 204 at image processor 210, while generating substantially the same results. System 200 may use machine-learning model 218 (of which neural network 300 may be an example) to conserve computation resources by decreasing an amount of image data processed by image processor 210 by decreasing a size of image data before processing the image data.

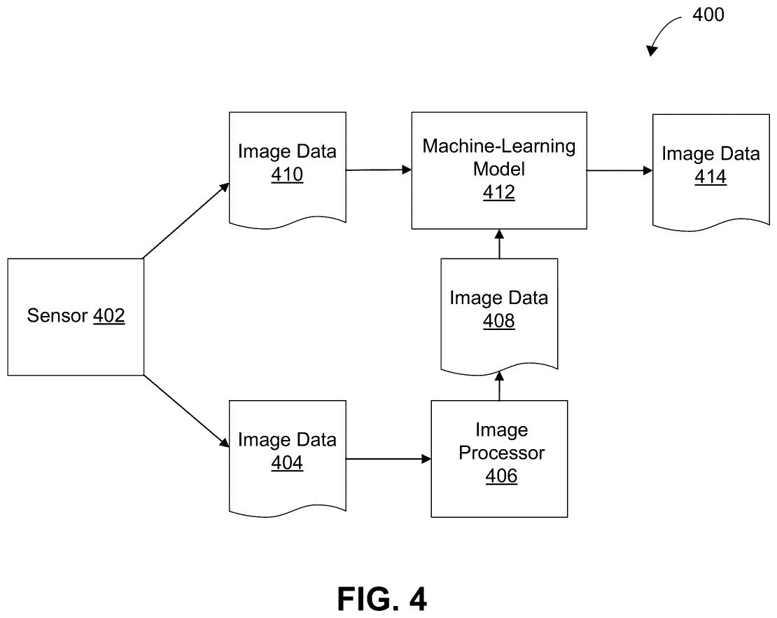

FIG. 4 is a diagram illustrating an example system 400 that may efficiently process image data 404 and image data 410, according to various aspects of the present disclosure. For example, system 400 may receive image data 404 and image data 410 from sensor 402. System 400 may include an image processor 406 to process image data 404 to generate image data 408 and a machine-learning model 412 to generate image data 414 based on image data 408 and image data 410. Image data 404 and image data 410 may be sequential images in a series of images (e.g., frames of video data). By processing image data 404 at image processor 406 and not processing image data 410 at image processor 406, system 400 may conserve computational resources compared with processing both image data 404 and image data 410 at image processor 406. Further, system 400 may use machine-learning model 412 to generate image data 414 which may be substantially similar to the result of processing image data 410 at image processor 406. In this way, system 400 may conserve computational resources, compared with processing image data 410 at image processor 406, while generating substantially the same results. System 400 may use machine-learning model 412 to conserve computation resources by decreasing an amount of image data processed by image processor 406 by decreasing a number of frames of image data processed by image processor 406.

Sensor 402 may be an example of image sensor 118 of FIG. 1 or an example of image-capture device 102 of FIG. 1. Sensor 402 may generate image data 404 and image data 410 based on light impinging on an array of photodetectors. Image data 404 and image data 410 may be according to any suitable format. For example, image data 404 and image data 410 may be raw image data, RGB image data, or luma, blue projection, red projection (YUV) image data. As mentioned above, image data 404 and image data 410 may be sequential images in a series of images (e.g., frames of video data). For example, image data 404 may be a first frame of video data and image data 410 may be a second frame (e.g., an immediately subsequent frame) of the video data. Based on a frame-capture rate of sensor 402 and based on a scene captured by sensor 402, many of the pixels of image data 410 may be the same as, or substantially similar to corresponding pixels of image data 404.

Image processor 406 may be implemented in, or be an example of, image processor 124 of FIG. 1. Image processor 406 may process image data 404 to generate image data 408 (which may be processed image data). Image processor 406 may perform a number of tasks, such as sensor-related processing (e.g., defect-pixel correction, and demosaicing), lens processing (e.g., shading correction), color correction, tone and gamma processing, noise reduction, sharpening color space conversion, pixel interpolation, automatic exposure control (AEC), automatic gain control (AGC), contrast detect autofocus (CDAF), automatic white balance, merging of image frames to form an HDR image, image recognition, object recognition, feature recognition, or some combination thereof.

Machine-learning model 412 may be implemented in image processor 124 or in another processor of image-processing device 104. Machine-learning model 412 may be trained to receive processed first image data and second image data as inputs and to generate processed second image data. For example, machine-learning model 412 may be trained using a back-propagation training technique by receiving processed image data (e.g., a processed first frame) and unprocessed image data (e.g., an unprocessed second frame) as inputs. Machine-learning model 412 may then generate processed second image data as an output. Separately, the second image data may be processed and the processed second image data may be compared to the output of machine-learning model 412 to determine a loss based on differences between the processed image data and the output of machine-learning model 412. Machine-learning model 412 may be adjusted (e.g., weights or parameters of machine-learning model 412 may be adjusted) to decrease the loss in further iterations of the training process. The back-propagation process may be repeated any number of times to train machine-learning model 412.

At inference (e.g., after training), machine-learning model 412 may receive image data 408 (e.g., which may be processed by image processor 406) and image data 410 as inputs. Machine-learning model 412 may include one or more convolutional layers. Based on image data 408 and image data 410, machine-learning model 412 may generate image data 414. Image data 414 may be substantially similar to image data that would result from processing image data 410 using image processor 406. For example, image data 414 may approximate the result of processing image data 410 with image processor 406. However, because, in system 400, image processor 406 does not process image data 410, system 400 conserves computational resources (processing time and power) when compared with a system that processes image data 410 using image processor 406.

Image data 408 and image data 414 may both be output by system 400. For example, image data 408 (which may be processed by image processor 406) and image data 414 (which may be substantially similar to the result of processing image data 410 at image processor 406) may be output by system 400. Similar to what was described above with regard to image data 220 of FIG. 2A, image data 408 and/or image data 414 may be displayed, stored, transmitted, and/or analyzed.

System 400 is illustrated and described a generating image data 414 based on two frames, a processed frame (image data 408) and an unprocessed frame (image data 410) as an example. In other aspects, system 400 may generates image data 414 based on another number of frames. As an example, image data 404 may be a first frame of video data and image data 410 may be a second frame of the video data. A third frame of the video data (not illustrated in FIG. 4) may be received and processed by image processor 406. In such a case, machine-learning model 412 may generate image data 414 based on the processed first frame (image data 408), the unprocessed second frame (image data 410), and the processed third frame (not illustrated in FIG. 4). As another example, system 400 may generate image data 414 based on three or four processed frames and one unprocessed frame.

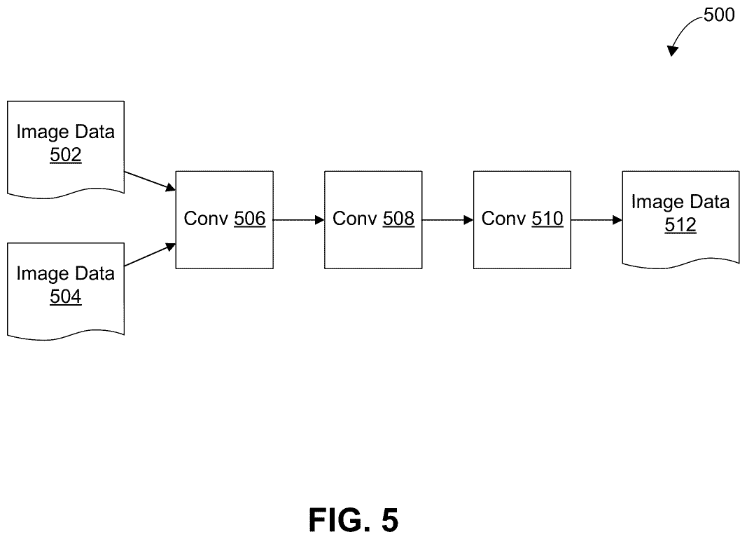

FIG. 5 is a diagram illustrating an example neural network 500 that may process image data 502 and image data 504, according to various aspects of the present disclosure. Neural network 500 may be an example of machine-learning model 412 of FIG. 4. Neural network 500 may receive image data 502 and image data 504 as inputs, provide image data 502 and image data 504 to a number of convolutional layers (e.g., a convolutional layer 506 a convolutional layer 508, and a convolutional layer 510). The number of convolutional layers may generate image data 512.

Image data 502 may be processed image data. For example, image data 502 may be an example of image data 408 of FIG. 4. For example, a first frame of video data may be processed (e.g., a processor that is the same as, or substantially similar to, and/or performs the same, or substantially the same, operations as image processor 406 of FIG. 4). Image data 502 may be the resulting processed image data. Image data 504 may be unprocessed image data. For example, image data 504 may be an example of image data 410 of FIG. 4. For example, image data 504 may be a second frame (e.g., immediately subsequent to the first frame) of the video data.

Each of convolutional layer 506, convolutional layer 508, and convolutional layer 510, may receive and convolve the image data in turn. For example, each of convolutional layer 506, convolutional layer 508, convolutional layer 510, may include a respective kernel with which convolutional layer 506, convolutional layer 508, convolutional layer 510 may in turn respectively convolve the image data. Further, each of convolutional layer 506, convolutional layer 508, convolutional layer 510 may include a respective linear unit (e.g., a ReLU or a PRELU). Convolutional layer 510 may generate image data 512.

Neural network 500 is described and illustrated with three convolutional layers as an example. In other aspects, neural network 500 may include any number of convolutional layers, for example, 2, 4, 5, 6, etc.

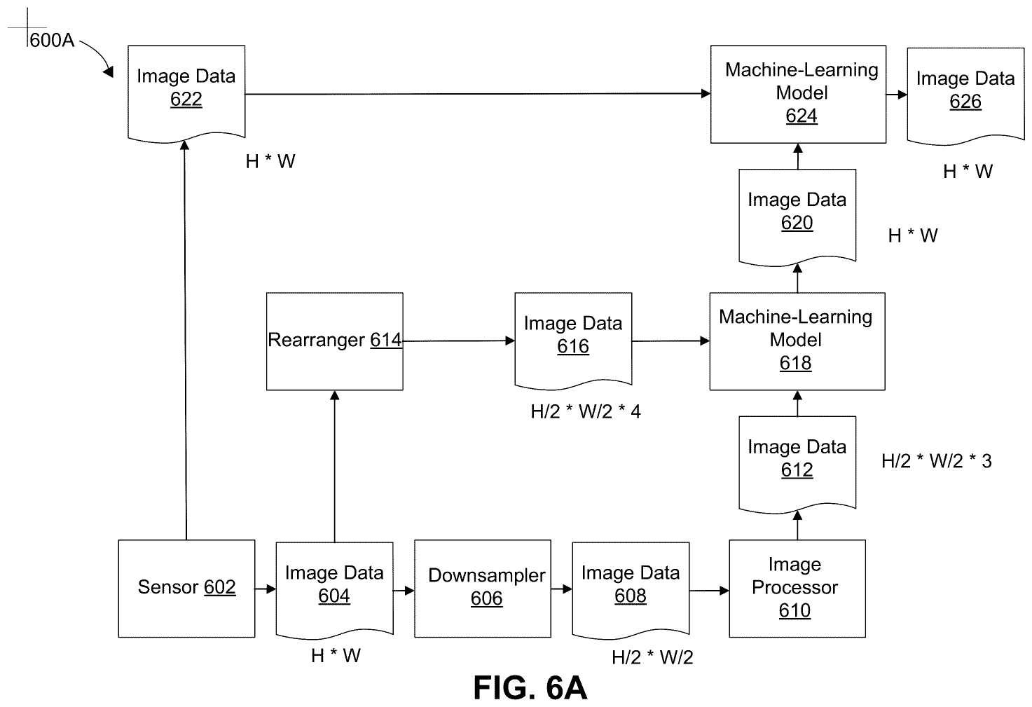

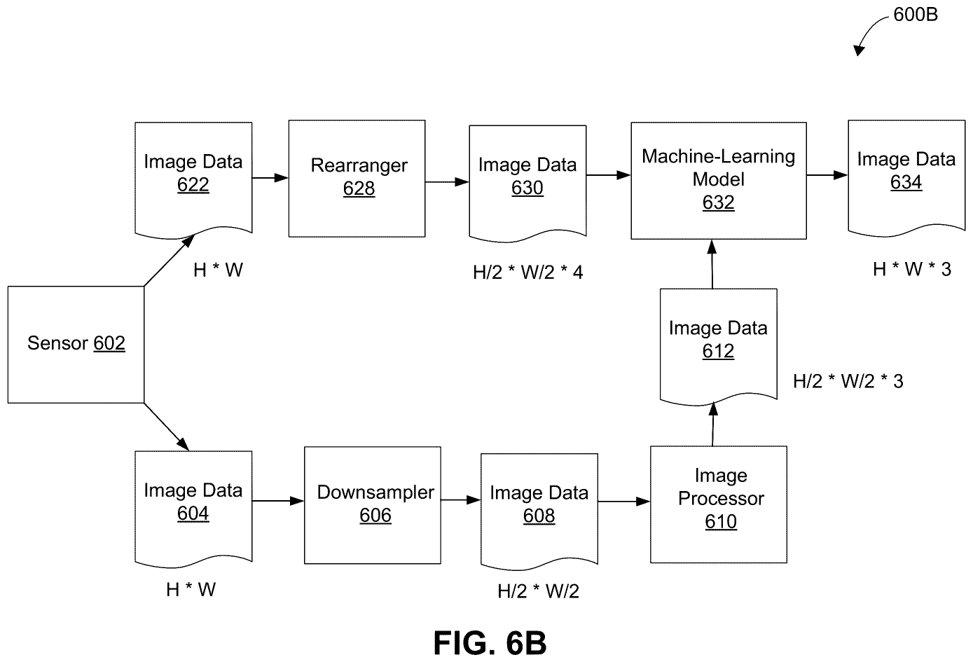

FIG. 6A is a diagram illustrating an example system 600A that may efficiently process image data 604 and image data 622, according to various aspects of the present disclosure. For example, system 600A may receive image data 604 and image data 622 from sensor 602. System 600A may include a downsampler 606 that may downsample image data 604 to generate image data 608, an image processor 610 to process image data 608 to generate image data 612, a rearranger 614 to rearrange image data 604 to generate image data 616, a first machine-learning model 618 to generate image data 620 based on image data 612 and image data 616, and a second machine-learning model 624 to generate image data 626 based on image data 620 and image data 622.

System 600A may implement or include system 200 and may benefit from the processing efficiencies of system 200. For example, system 600A downsampler 606, image processor 610, rearranger 614, and machine-learning model 618 may implement system 200. For example, image data 604 may play the same role in system 600A as image data 204 of FIG. 2A plays in system 200. Downsampler 606 may be the same as, may be substantially similar to, and/or may perform the same, or substantially the same, operations as downsampler 206 of FIG. 2A. Image data 608 may be the same as, or may be substantially similar to, image data 208 of FIG. 2A. Image processor 610 may be the same as, may be substantially similar to, and/or may perform the same, or substantially the same, operations as image processor 210 of FIG. 2A. Image data 612 may be the same as, or may be substantially similar to, image data 212 of FIG. 2A. Rearranger 614 may be the same as, may be substantially similar to, and/or may perform the same, or substantially the same, operations as rearranger 214 of FIG. 2A. Image data 616 may be the same as, or may be substantially similar to, image data 216 of FIG. 2A. Machine-learning model 618 may be the same as, may be substantially similar to, and/or may perform the same, or substantially the same, operations as machine-learning model 218 of FIG. 2A. Neural network 300 of FIG. 3A may be an example of machine-learning model 618 of FIG. 6A. Image data 620 may be the same as, or may be substantially similar to, image data 220 of FIG. 2A.

System 600A may implement or include system 400 and may benefit from the processing efficiencies of system 400. For example, system 600A downsampler 606, image processor 610, rearranger 614, and machine-learning model 618 may implement image processor 406 of FIG. 4 and machine-learning model 624 may be the same as, may be substantially similar to, and/or may perform the same, or substantially the same, operations as machine-learning model 412 of FIG. 4. For example, image data 604 may play the same role in system 600A as image data 404 of FIG. 4 plays in system 400. Downsampler 606, image processor 610, rearranger 614, and machine-learning model 618 may play the same role in system 600A as image processor 406 of FIG. 4 plays in system 400. Image data 620 may play the same role in system 600A as image data 408 of FIG. 4 plays in system 400. Image data 622 may play the same role in system 600A as image data 410 of FIG. 4 plays in system 400. Machine-learning model 624 may be the same as, may be substantially similar to, and/or may perform the same, or substantially the same, operations as machine-learning model 412 of FIG. 4. Image data 626 may play the same role in system 600A as image data 414 of FIG. 4 plays in system 400.

By processing image data 608 at image processor 610 rather than processing image data 604 at image processor 610, system 600A may conserve computational resources compared with processing image data 604 at image processor 610. Further, system 600A may use machine-learning model 618 (of which neural network 300 of FIG. 3A may be an example) to generate image data 620 which may be substantially similar to the result of processing image data 604 at image processor 610. In this way, system 600A may conserve computational resources, compared with processing image data 604 at image processor 610, while generating substantially the same results. In this way, system 600A may use machine-learning model 618 (of which neural network 300 may be an example) to conserve computation resources by decreasing an amount of image data processed by image processor 610 by decreasing a size of image data before processing the image data.

Additionally, image data 604 and image data 622 may be sequential images in a series of images (e.g., frames of video data). By processing image data 608 (which is based on image data 604) at image processor 610 and not processing image data 622 at image processor 610, system 600A may conserve computational resources compared with processing both image data 604 and image data 622 at image processor 610. Further, system 600A may use machine-learning model 624 (of which neural network 500 of FIG. 5 may be an example) to generate image data 626 which may be substantially similar to the result of processing image data 622 at image processor 610. In this way, system 600A may conserve computational resources, compared with processing image data 622 at image processor 610, while generating substantially the same results. In this way, system 600A may use machine-learning model 624 (of which neural network 500 of FIG. 5 may be an example) to conserve computation resources by decreasing an amount of image data processed by image processor 610 by decreasing a number of frames of image data processed by image processor 610.

FIG. 6B is a diagram illustrating an example system 600B that may efficiently process image data 604 and image data 622, according to various aspects of the present disclosure. For example, system 600B may receive image data 604 and image data 622 from sensor 602. System 600B may include a downsampler 606 to downsample image data 604 to generate image data 608 and a rearranger 628 to rearrange image data 622 to generate image data 630. Further system 600B may include an image processor 610 to process image data 612 to generate image data 608 and a machine-learning model 632 to generate image data 634 based on image data 612 and image data 630.

System 600B may implement or include system 200 and may benefit from the processing efficiencies of system 200. For example, system 600B downsampler 606, image processor 610, rearranger 628, and machine-learning model 632 may implement system 200. For example, image data 604 may play the same role in system 600B as image data 204 of FIG. 2A plays in system 200. Downsampler 606 may be the same as, may be substantially similar to, and/or may perform the same, or substantially the same, operations as downsampler 206 of FIG. 2A. Image data 608 may be the same as, or may be substantially similar to, image data 208 of FIG. 2A. Image processor 610 may be the same as, may be substantially similar to, and/or may perform the same, or substantially the same, operations as image processor 210 of FIG. 2A. Image data 612 may be the same as, or may be substantially similar to, image data 212 of FIG. 2A. Rearranger 628 may be the same as, may be substantially similar to, and/or may perform the same, or substantially the same, operations as rearranger 214 of FIG. 2A. However, rearranger 628 may rearrange image data 622, which may be a second frame (e.g., following image data 604) of a series of sequential frames. Machine-learning model 632 may, among other things, perform substantially the same operations as machine-learning model 218 of FIG. 2A.

System 600B may implement or include system 400 and may benefit from the processing efficiencies of system 400. For example, system 600B downsampler 606, image processor 610, rearranger 614, and machine-learning model 632 may implement image processor 406 of FIG. 4 and machine-learning model 632 may, among other things, perform substantially the same operations as machine-learning model 412 of FIG. 4. For example, image data 604 may play the same role in system 600B as image data 404 of FIG. 4 plays in system 400. Downsampler 606, image processor 610, rearranger 614, and machine-learning model 632 may play the same role in system 600B as image processor 406 of FIG. 4 plays in system 400. Image data 612 may play the same role in system 600B as image data 408 of FIG. 4 plays in system 400. Image data 630 may play the same role in system 600B as image data 410 of FIG. 4 plays in system 400. Machine-learning model 632 may, among other things, perform substantially the same operations as machine-learning model 412 of FIG. 4. Image data 634 may play the same role in system 600B as image data 414 of FIG. 4 plays in system 400.

For example, sensor 602 may provide Image data 604 and image data 622. Image data 604 and image data 622 may be sequential images in a series of images (e.g., frames of video data). Downsampler 606 may downsample image data 604 to generate Image data 608. Image data 608 may be smaller than image data 604. For example, image data 604 may have a size of H*W and image data 608 may have a size of H/2*W/2. Image processor 610 may process image processor 610 to generate image data 612 (which may have a size of H/2*W/2*3). Rearranger 628 may rearrange image data 622 to generate Image data 630. Image data 630 may have the same size as image data 622, but may be rearranged. For example, image data 622 may have dimensions of H*W and image data 630 may have dimensions of H/2*W/2*4. Machine-learning model 632 may process image data 612 and image data 630 to generate image data 634.

Machine-learning model 632 may perform operations substantially similar to machine-learning model 218 of system 200 of FIG. 2A and machine-learning model 412 of system 400 of FIG. 4. Machine-learning model 632 may be implemented in image processor 124 or in another processor of image-processing device 104. Machine-learning model 412 may be trained to receive processed lower-resolution first image data and rearranged second image data as inputs and to generate processed second image data. For example, machine-learning model 632 may be trained using a back-propagation training technique by receiving processed lower-resolution image data (e.g., a processed first frame having a lower than original resolution) and unprocessed rearranged image data (e.g., an unprocessed second frame) as inputs. Machine-learning model 632 may then generate processed full-resolution second image data as an output. Separately, the second image data may be processed (at full resolution) and the processed second image data may be compared to the output of machine-learning model 632 to determine a loss based on differences between the processed image data and the output of machine-learning model 632. Machine-learning model 632 may be adjusted (e.g., weights or parameters of machine-learning model 632 may be adjusted) to decrease the loss in further iterations of the training process. The back-propagation process may be repeated any number of times to train machine-learning model 632.

At inference (e.g., after training), machine-learning model 632 may receive image data 612 (e.g., which may be processed by image processor 610) (which may be a tensor having dimensions of H/2*W/2*3) and image data 630 (which may be a tensor having dimensions of H/2*W/2*4) as inputs. In some cases, image data 612 and image data 630 may be concatenated together to form a single tensor having dimensions of H/2*W/2*7.Machine-learning model 632 may include one or more convolutional layers. The convolutional layers may be sized to operate according to the dimensions of the single tensor (H/2*W/2*7). Based on image data 612 and image data 630, machine-learning model 632 may generate image data 634. Image data 634 may be substantially similar to image data that would result from processing image data 622 using image processor 610. Image data 634 may have dimensions of H*W (e.g., image data 634 may be full-resolution image data). For example, image data 634 may approximate the result of processing image data 622 with image processor 610. However, because, in system 600B, image processor 610 does not process image data 622, system 600B conserves computational resources (processing time and power) when compared with a system that processes image data 622 using image processor 610.

By processing image data 608 at image processor 610 rather than processing image data 604 at image processor 610, system 600B may conserve computational resources compared with processing image data 604 at image processor 610. Additionally, image data 604 and image data 622 may be sequential images in a series of images (e.g., frames of video data). By processing image data 608 (which is based on image data 604) at image processor 610 and not processing image data 622 at image processor 610, system 600B may conserve computational resources compared with processing both image data 604 and image data 622 at image processor 610. Further, system 600B may use machine-learning model 632 to generate image data 634 which may be substantially similar to the result of processing image data 622 at image processor 610. In this way, system 600B may conserve computational resources, compared with processing image data 622 at image processor 610, while generating substantially the same results. In this way, system 600B may use machine-learning model 632 to conserve computation resources by decreasing an amount of image data processed by image processor 610 by decreasing a number of frames of image data processed by image processor 610.

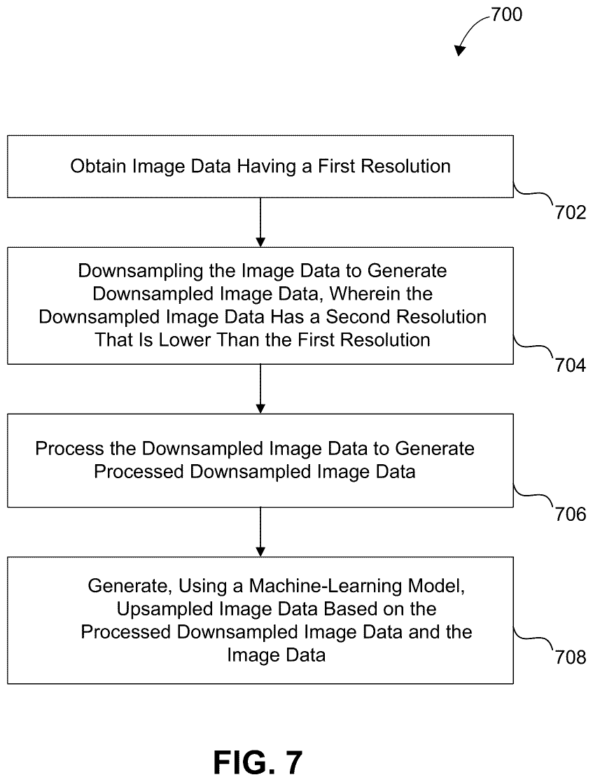

FIG. 7 is a flow diagram illustrating a process 700 for processing image data, in accordance with aspects of the present disclosure. One or more operations of process 700 may be performed by a computing device (or apparatus) or a component (e.g., a chipset, codec, etc.) of the computing device. The computing device may be a camera, a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. The one or more operations of process 700 may be implemented as software components that are executed and run on one or more processors.

At a block 702, a computing device (or one or more components thereof) may obtain image data having a first resolution. For example, system 200 of FIG. 2A may obtain image data 204. Image data 204 may have a first resolution (e.g., H*W).

At a block 704, the computing device (or one or more components thereof) may downsample the image data to generate downsampled image data, wherein the downsampled image data has a second resolution that is lower than the first resolution. For example, downsampler 206 of system 200 may downsample image data 204 to generate image data 208. Image data 208 may have a second resolution (e.g., H/2*W/2). In some aspects, to downsample the image data, the computing device (or one or more components thereof) may bin the image data (e.g., as illustrated and described with respect to FIG. 2B).

At a block 706, the computing device (or one or more components thereof) may process the downsampled image data to generate processed downsampled image data. For example, image processor 210 of system 200 may process image data 208 to generate image data 212.

In some aspects, processing the image data at block 706 may be, or may include, applying one or more filters to the downsampled image data; reducing noise in the downsampled image data; sharpening the downsampled image data; de-mosaicing the downsampled image data; and/or re-mosaicing the downsampled image data. In same aspects, at block 706 the computing device (or one or more components thereof) may to perform sensor-related processing (e.g., defect-pixel correction, and demosaicing), lens processing (e.g., shading correction), color correction, tone and gamma processing, noise reduction, sharpening color space conversion, pixel interpolation, automatic exposure control (AEC), automatic gain control (AGC), contrast detect autofocus (CDAF), automatic white balance, merging of image frames to form an HDR image, image recognition, object recognition, feature recognition, or some combination thereof.

At a block 708, the computing device (or one or more components thereof) may generate, using a machine-learning model, upsampled image data based on the processed downsampled image data and the image data. For example, machine-learning model 218 of system 200 may generate image data 220 based on image data 212 and image data 216 (which image data 216 may be image data 204 rearranged).

In some aspects, the upsampled image data may have the first resolution. For example, the image data may be full-resolution image data and the upsampled image data may also be full-resolution image data. In some aspects, the image data may be, or may include, raw image data captured by an image sensor of a device and the downsampled image data may be processed by an image signal processor (ISP) of the device. For example, image data 204 may have been captured by sensor 202 of system 200 and image data 212 may be processed by image processor 210 of system 200.

In some aspects, the computing device (or one or more components thereof) may rearrange the image data to generate rearranged image data; and provide the rearranged image data and the downsampled image data as inputs to the machine-learning model. For example, rearranger 214 of system 200 may rearrange image data 204 to generate image data 216 and provide image data 216 and image data 212 to machine-learning model 218. In some aspects, to rearrange the image data, the computing device (or one or more components thereof) may rearrange the image data as a tensor with dimensions related to dimensions of the downsampled image data. For example, rearranger 214 may rearrange image data 204 to have dimensions H/2*W/2*4 based on image data 208 having dimensions of H/2*W/2 and/or based on image data 212 having dimensions of H/2*W/2*3.

In some aspects, the machine-learning model may be trained to receive first image data having the first resolution and second image data having the second resolution as inputs and to generate third image data having the first resolution. In some aspects, machine-learning model may be, or may include, a neural network comprising two or more convolutional layers.

In some aspects, the computing device (or one or more components thereof) may display, store, and/or transmit the upsampled image data.

In some aspects, wherein the image data may be first image data, and the computing device (or one or more components thereof) may obtain second image data; and generate, processed second image data based on the upsampled image data and the second image data. For example, system 600A of FIG. 6A may obtain image data 604 (which may be first image data) (e.g., at block 702). System 600A may downsample image data 604 at downsampler 606 to generate image data 608 (e.g., at block 704). 600A may process image data 608 at image processor 610 to generate image data 612 (e.g., at block 706). System 600A may use machine-learning model 618 to generate image data 620 based on image data 612 and image data 616 (which may be image data 604 rearranged). System 600A may obtain image data 622 (which may be second image data). System 600A may provide image data 620 and image data 622 to machine-learning model 624 to generate image data 626 (e.g., at block 708).

In such aspects, the first image data may be a first frame of video data and the second image data may be a second frame of the image data. In some aspects, the computing device (or one or more components thereof) may further obtain third image data, process the third image data to generate processed third image data. In such aspects, the processed second image data may be generated further based on the processed third image data.

In some aspects, the computing device (or one or more components thereof) may obtain second image data having the first resolution; downsample the second image data to generate downsampled second image data, wherein the downsampled second image data has the second resolution; process the downsampled second image data to generate processed downsampled second image data; and generate, using the machine-learning model, upsampled second image data based on the processed downsampled second image data and the second image data. For example, subsequent to processing image data 204 to generate image data 220, system 200 may receive second image data and may downsample the second image data at downsampler 206 to generate second downsampled image data. System 200 may process the second downsampled image data at image processor 210 to generate second processed image data. System 200 may provide the second processed image data and second rearranged image data to machine-learning model 218 to generate second upsampled image data.

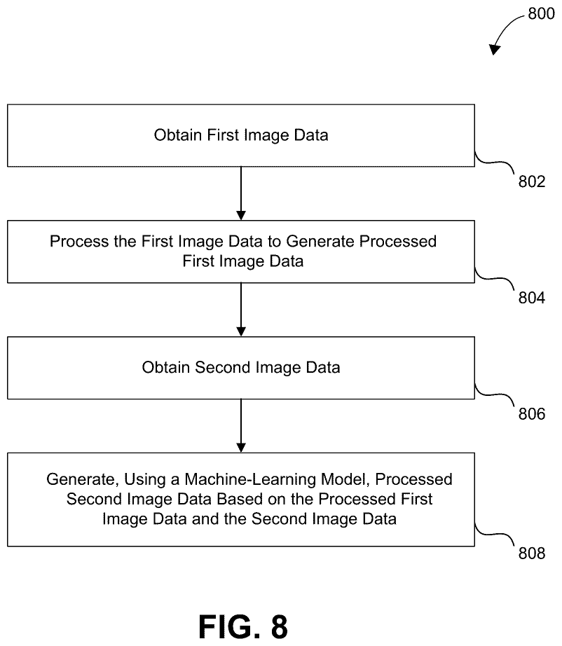

FIG. 8 is a flow diagram illustrating a process 800 for processing image data, in accordance with aspects of the present disclosure. One or more operations of process 800 may be performed by a computing device (or apparatus) or a component (e.g., a chipset, codec, etc.) of the computing device. The computing device may be a camera, a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the process 800. The one or more operations of process 800 may be implemented as software components that are executed and run on one or more processors.

At a block 802, a computing device (or one or more components thereof) may obtain first image data. For example, system 400 of FIG. 4 may obtain image data 404.

At a block 804, the computing device (or one or more components thereof) may process the first image data to generate processed first image data. For example, system 400 may process image data 404 at image processor 406 to generate image data 408.

In some aspects, processing the image data at block 804 may be, or may include, applying one or more filters to the downsampled image data; reducing noise in the downsampled image data; sharpening the downsampled image data; de-mosaicing the downsampled image data; and/or re-mosaicing the downsampled image data. In same aspects, at block 804 the computing device (or one or more components thereof) may to perform sensor-related processing (e.g., defect-pixel correction, and demosaicing), lens processing (e.g., shading correction), color correction, tone and gamma processing, noise reduction, sharpening color space conversion, pixel interpolation, automatic exposure control (AEC), automatic gain control (AGC), contrast detect autofocus (CDAF), automatic white balance, merging of image frames to form an HDR image, image recognition, object recognition, feature recognition, or some combination thereof.

At a block 806, the computing device (or one or more components thereof) may obtain second image data. For example, system 400 may obtain image data 410. In some aspects, the first image data may be a first frame of video data; and the second image data may be a second frame of the video data.

At a block 808, the computing device (or one or more components thereof) may generate, using a machine-learning model, processed second image data based on the processed first image data and the second image data. For example, system 400 may provide image data 408 and image data 410 to machine-learning model 412 and machine-learning model 412 may generate image data 414 based on image data 408 and image data 410.

In some aspects, the machine-learning model may be trained to receive image data and first processed image data as inputs and to generate second processed image data. In some aspects, the machine-learning model may be, or may include, a neural network comprising two or more convolutional layers.

In some aspects, the computing device (or one or more components thereof) may obtain third image data; and process the third image data to generate processed third image data. In such aspects, the second image data may be generated further based on the processed third image data. For example, system 400 may obtain third image data and process the third image data at image processor 406 to generate processed third image data. System 400 may provide the processed third image data to machine-learning model 412 along with image data 408 and image data 410 to generate image data 414.

In some aspects, to process the first image data, the computing device (or one or more components thereof) may downsample the first image data to generate downsampled first image data; process the downsampled first image data to generate processed downsampled image data; and generate upsampled first image data based on the processed downsampled image data and the first image data. In such aspects, the processed second image data may be generated based on the upsampled first image data. For example, system 600A of FIG. 6A may obtain image data 604 (which may be first image data) (e.g., at block 802). System 600A may downsample image data 604 at downsampler 606 to generate image data 608 and process image data 608 at image processor 610 to generate image data 612 (e.g., at block 804). System 600A may use machine-learning model 618 to generate image data 620 based on image data 612 and image data 616 (which may be image data 604 rearranged) (e.g., at block 804). System 600A may obtain image data 622 (which may be second image data) (e.g., at block 806). System 600A may provide image data 620 and image data 622 to machine-learning model 624 to generate image data 626 (e.g., at block 808).

In some examples, as noted previously, the methods described herein (e.g., process 700 of FIG. 7, process 800 of FIG. 8, and/or other methods described herein) can be performed, in whole or in part, by a computing device or apparatus. In one example, one or more of the methods can be performed by image-processing device 104 of FIG. 1, image processor 124 of FIG. 1, host processor 126 of FIG. 1, ISP 128 of FIG. 1, system 200 of FIG. 2A, neural network 300 of FIG. 3A, system 400 of FIG. 4, neural network 500 of FIG. 5, system 600A of FIG. 6A, system 600B of FIG. 6B or by another system or device. In another example, one or more of the methods (e.g., process 700 of FIG. 7, process 800 of FIG. 8, and/or other methods described herein) can be performed, in whole or in part, by the computing-device architecture 1100 shown in FIG. 11. For instance, a computing device with the computing-device architecture 1100 shown in FIG. 11 can include, or be included in, the components of the image-processing device 104 of FIG. 1, image processor 124 of FIG. 1, host processor 126 of FIG. 1, ISP 128 of FIG. 1, system 200 of FIG. 2A, neural network 300 of FIG. 3A, system 400 of FIG. 4, neural network 500 of FIG. 5, system 600A of FIG. 6A, system 600B of FIG. 6B and can implement the operations of process 700, process 800, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 700, process 800, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 700, process 800, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

As noted above, various aspects of the present disclosure can use machine-learning models or systems.

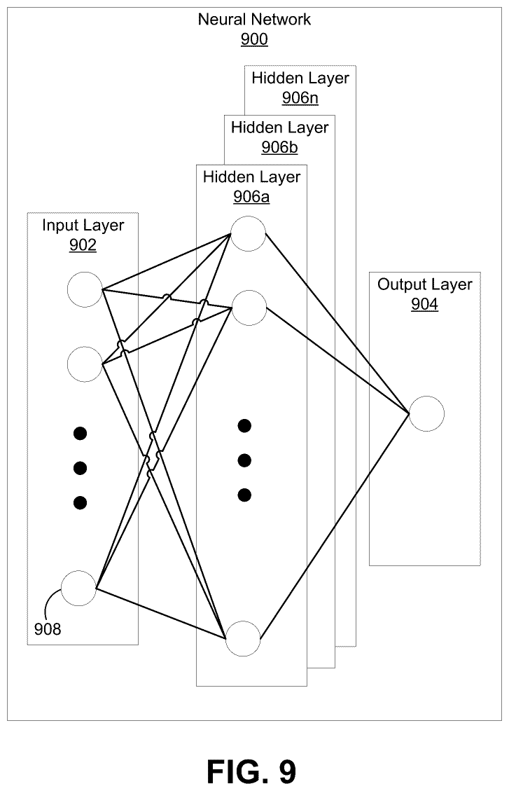

FIG. 9 is an illustrative example of a neural network 900 (e.g., a deep-learning neural network) that can be used to implement the machine-learning based image processing, image generation, feature segmentation, implicit-neural-representation generation, rendering, and/or classification described above. Neural network 900 may be an example of, or can implement, machine-learning model 218 of FIG. 2A, neural network 300 of FIG. 3A, machine-learning model 412 of FIG. 4, neural network 500 of FIG. 5, machine-learning model 618 of FIG. 6A, machine-learning model 624 of FIG. 6A and/or machine-learning model 632 of FIG. 6B.

An input layer 902 includes input data. In one illustrative example, input layer 902 can include image data (e.g., image data 212 of FIG. 2A, image data 216 of FIG. 2A, image data 302 of FIG. 3A, image data 304 of FIG. 3A, image data 408 of FIG. 4, image data 410 of FIG. 4, image data 502 of FIG. 5, image data 504 of FIG. 5, image data 612 of FIG. 6A, image data 616 of FIG. 6A, image data 620 of FIG. 6A, image data 622 of FIG. 6A, image data 612 of FIG. 6B, and/or image data 630 of FIG. 6B. Neural network 900 includes multiple hidden layers hidden layers 906a, 906b, through 906n. The hidden layers 906a, 906b, through hidden layer 906n include “n” number of hidden layers, where “n” is an integer greater than or equal to one. The number of hidden layers can be made to include as many layers as needed for the given application. Neural network 900 further includes an output layer 904 that provides an output resulting from the processing performed by the hidden layers 906a. 906b, through 906n. In one illustrative example, output layer 904 can provide image data (e.g., image data 220 of FIG. 2A, image data 320 of FIG. 3A, image data 414 of FIG. 4, image data 512 of FIG. 5, image data 620 of FIG. 6A, image data 626 of FIG. 6A, and/or image data 634 of FIG. 6B.

Neural network 900 may be, or may include, a multi-layer neural network of interconnected nodes. Each node can represent a piece of information. Information associated with the nodes is shared among the different layers and each layer retains information as information is processed. In some cases, neural network 900 can include a feed-forward network, in which case there are no feedback connections where outputs of the network are fed back into itself. In some cases, neural network 900 can include a recurrent neural network, which can have loops that allow information to be carried across nodes while reading in input.

Information can be exchanged between nodes through node-to-node interconnections between the various layers. Nodes of input layer 902 can activate a set of nodes in the first hidden layer 906a. For example, as shown, each of the input nodes of input layer 902 is connected to each of the nodes of the first hidden layer 906a. The nodes of first hidden layer 906a can transform the information of each input node by applying activation functions to the input node information. The information derived from the transformation can then be passed to and can activate the nodes of the next hidden layer 906b, which can perform their own designated functions. Example functions include convolutional, up-sampling, data transformation, and/or any other suitable functions. The output of the hidden layer 906b can then activate nodes of the next hidden layer, and so on. The output of the last hidden layer 906n can activate one or more nodes of the output layer 904, at which an output is provided. In some cases, while nodes (e.g., node 908) in neural network 900 are shown as having multiple output lines, a node has a single output and all lines shown as being output from a node represent the same output value.

In some cases, each node or interconnection between nodes can have a weight that is a set of parameters derived from the training of neural network 900. Once neural network 900 is trained, it can be referred to as a trained neural network, which can be used to perform one or more operations. For example, an interconnection between nodes can represent a piece of information learned about the interconnected nodes. The interconnection can have a tunable numeric weight that can be tuned (e.g., based on a training dataset), allowing neural network 900 to be adaptive to inputs and able to learn as more and more data is processed.

Neural network 900 may be pre-trained to process the features from the data in the input layer 902 using the different hidden layers 906a, 906b, through 906n in order to provide the output through the output layer 904. In an example in which neural network 900 is used to identify features in images, neural network 900 can be trained using training data that includes both images and labels, as described above. For instance, training images can be input into the network, with each training image having a label indicating the features in the images (for the feature-segmentation machine-learning system) or a label indicating classes of an activity in each image. In one example using object classification for illustrative purposes, a training image can include an image of a number 2, in which case the label for the image can be [001000000 0].

In some cases, neural network 900 can adjust the weights of the nodes using a training process called backpropagation. As noted above, a backpropagation process can include a forward pass, a loss function, a backward pass, and a weight update. The forward pass, loss function, backward pass, and parameter update is performed for one training iteration. The process can be repeated for a certain number of iterations for each set of training images until neural network 900 is trained well enough so that the weights of the layers are accurately tuned.

For the example of identifying objects in images, the forward pass can include passing a training image through neural network 900. The weights are initially randomized before neural network 900 is trained. As an illustrative example, an image can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for neural network 900, the output will likely include values that do not give preference to any particular class due to the weights being randomly selected at initialization. For example, if the output is a vector with probabilities that the object includes different classes, the probability value for each of the different classes can be equal or at least very similar (e.g., for ten possible classes, each class can have a probability value of 0.1). With the initial weights, neural network 900 is unable to determine low-level features and thus cannot make an accurate determination of what the classification of the object might be. A loss function can be used to analyze error in the output. Any suitable loss function definition can be used, such as a cross-entropy loss. Another example of a loss function includes the mean squared error (MSE), defined as

$${E}_{total} = \sum \frac{1}{2} {( target - output )}^{2} .$$

The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. Neural network 900 can perform a backward pass by determining which inputs (weights) most contributed to the loss of the network and can adjust the weights so that the loss decreases and is eventually minimized. A derivative of the loss with respect to the weights (denoted as dLldW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{d L}{dW} ,$$

where w denotes a weight, wᵢ denotes the initial weight, and n denotes a learning rate. The learning rate can be set to any suitable value, with a high learning rate including larger weight updates and a lower value indicating smaller weight updates.

Neural network 900 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. Neural network 900 can include any other deep network other than a CNN, such as an autoencoder, a deep belief nets (DBNs), a Recurrent Neural Networks (RNNs), among others.

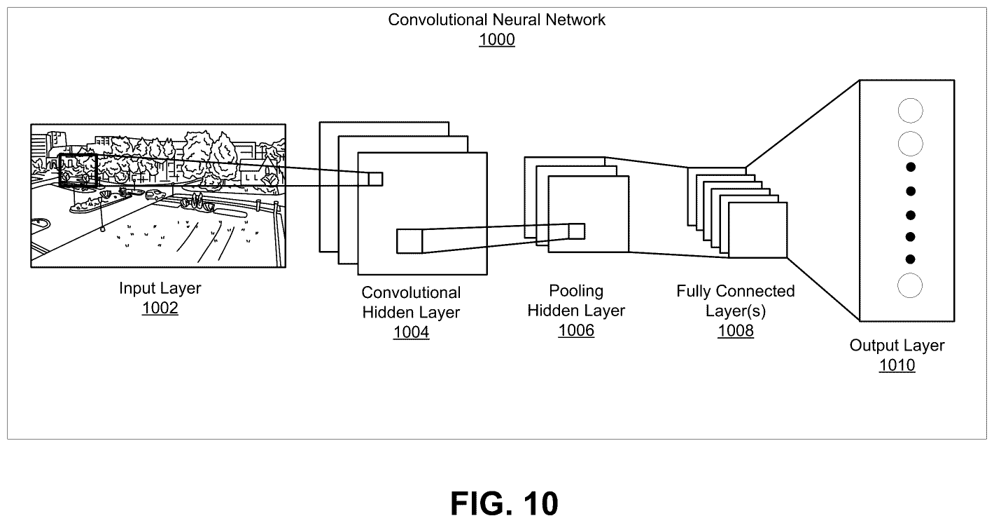

FIG. 10 is an illustrative example of a convolutional neural network (CNN) 1000. The input layer 1002 of the CNN 1000 includes data representing an image or frame. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 1004, an optional non-linear activation layer, a pooling hidden layer 1006, and fully connected layer 1008 (which fully connected layer 1008 can be hidden) to get an output at the output layer 1010. While only one of each hidden layer is shown in FIG. 10, one of ordinary skill will appreciate that multiple convolutional hidden layers, non-linear layers, pooling hidden layers, and/or fully connected layers can be included in the CNN 1000. As previously described, the output can indicate a single class of an object or can include a probability of classes that best describe the object in the image.

The first layer of the CNN 1000 can be the convolutional hidden layer 1004. The convolutional hidden layer 1004 can analyze image data of the input layer 1002. Each node of the convolutional hidden layer 1004 is connected to a region of nodes (pixels) of the input image called a receptive field. The convolutional hidden layer 1004 can be considered as one or more filters (each filter corresponding to a different activation or feature map), with each convolutional iteration of a filter being a node or neuron of the convolutional hidden layer 1004. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 1004. Each connection between a node and a receptive field for that node learns a weight and, in some cases, an overall bias such that each node learns to analyze its particular local receptive field in the input image. Each node of the convolutional hidden layer 1004 will have the same weights and bias (called a shared weight and a shared bias). For example, the filter has an array of weights (numbers) and the same depth as the input. A filter will have a depth of 3 for an image frame example (according to three color components of the input image). An illustrative example size of the filter array is 5×5×3, corresponding to a size of the receptive field of a node.

The convolutional nature of the convolutional hidden layer 1004 is due to each node of the convolutional layer being applied to its corresponding receptive field. For example, a filter of the convolutional hidden layer 1004 can begin in the top-left corner of the input image array and can convolve around the input image. As noted above, each convolutional iteration of the filter can be considered a node or neuron of the convolutional hidden layer 1004. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 1004. For example, a filter can be moved by a step amount (referred to as a stride) to the next receptive field. The stride can be set to 1 or any other suitable amount. For example, if the stride is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 1004.

The mapping from the input layer to the convolutional hidden layer 1004 is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a stride of 1) of a 28×28 input image. The convolutional hidden layer 1004 can include several activation maps in order to identify multiple features in an image. The example shown in FIG. 10 includes three activation maps. Using three activation maps, the convolutional hidden layer 1004 can detect three different kinds of features, with each feature being detectable across the entire image.

In some examples, a non-linear hidden layer can be applied after the convolutional hidden layer 1004. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 1000 without affecting the receptive fields of the convolutional hidden layer 1004.

The pooling hidden layer 1006 can be applied after the convolutional hidden layer 1004 (and after the non-linear hidden layer when used). The pooling hidden layer 1006 is used to simplify the information in the output from the convolutional hidden layer 1004. For example, the pooling hidden layer 1006 can take each activation map output from the convolutional hidden layer 1004 and generates a condensed activation map (or feature map) using a pooling function. Max-pooling is one example of a function performed by a pooling hidden layer. Other forms of pooling functions be used by the pooling hidden layer 1006, such as average pooling, L2-norm pooling, or other suitable pooling functions. A pooling function (e.g., a max-pooling filter, an L2-norm filter, or other suitable pooling filter) is applied to each activation map included in the convolutional hidden layer 1004. In the example shown in FIG. 10, three pooling filters are used for the three activation maps in the convolutional hidden layer 1004.

In some examples, max-pooling can be used by applying a max-pooling filter (e.g., having a size of 2×2) with a stride (e.g., equal to a dimension of the filter, such as a stride of 2) to an activation map output from the convolutional hidden layer 1004. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 1004 having a dimension of 24×24 nodes, the output from the pooling hidden layer 1006 will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

The pooling function (e.g., max-pooling, L2-norm pooling, or other pooling function) determines whether a given feature is found anywhere in a region of the image and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 1000.

The final layer of connections in the network is a fully-connected layer that connects every node from the pooling hidden layer 1006 to every one of the output nodes in the output layer 1010. Using the example above, the input layer includes 28×28 nodes encoding the pixel intensities of the input image, the convolutional hidden layer 1004 includes 3×24×24 hidden feature nodes based on application of a 5×5 local receptive field (for the filters) to three activation maps, and the pooling hidden layer 1006 includes a layer of 3×12×12 hidden feature nodes based on application of max-pooling filter to 2×2 regions across each of the three feature maps. Extending this example, the output layer 1010 can include ten output nodes. In such an example, every node of the 3×12×12 pooling hidden layer 1006 is connected to every node of the output layer 1010.

The fully connected layer 1008 can obtain the output of the previous pooling hidden layer 1006 (which should represent the activation maps of high-level features) and determines the features that most correlate to a particular class. For example, the fully connected layer 1008 can determine the high-level features that most strongly correlate to a particular class and can include weights (nodes) for the high-level features. A product can be computed between the weights of the fully connected layer 1008 and the pooling hidden layer 1006 to obtain probabilities for the different classes. For example, if the CNN 1000 is being used to predict that an object in an image is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 1010 can include an M-dimensional vector (in the prior example, M=10). M indicates the number of classes that the CNN 1000 has to choose from when classifying the object in the image. Other example outputs can also be provided. Each number in the M-dimensional vector can represent the probability the object is of a certain class. In one illustrative example, if a 10-dimensional output vector represents ten different classes of objects is [0 0 0.05 0.8 00.15 000 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

FIG. 11 illustrates an example computing-device architecture 1100 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 1100 may include, implement, or be included in any or all of image-processing device 104 of FIG. 1, image processor 124 of FIG. 1, host processor 126 of FIG. 1, ISP 128 of FIG. 1, system 200 of FIG. 2A, neural network 300 of FIG. 3A, system 400 of FIG. 4, neural network 500 of FIG. 5, system 600A of FIG. 6A, system 600B of FIG. 6B.

The components of computing-device architecture 1100 are shown in electrical communication with each other using connection 1112, such as a bus. The example computing-device architecture 1100 includes a processing unit (CPU or processor) 1102 and computing device connection 1112 that couples various computing device components including computing device memory 1110, such as read only memory (ROM) 1108 and random-access memory (RAM) 1106, to processor 1102.

Computing-device architecture 1100 can include a cache of high-speed memory connected directly with, in close proximity to, or integrated as part of processor 1102. Computing-device architecture 1100 can copy data from memory 1110 and/or the storage device 1114 to cache 1104 for quick access by processor 1102. In this way, the cache can provide a performance boost that avoids processor 1102 delays while waiting for data. These and other modules can control or be configured to control processor 1102 to perform various actions. Other computing device memory 1110 may be available for use as well. Memory 1110 can include multiple different types of memory with different performance characteristics. Processor 1102 can include any general-purpose processor and a hardware or software service, such as service 1 1116, service 2 1118, and service 3 1120 stored in storage device 1114, configured to control processor 1102 as well as a special-purpose processor where software instructions are incorporated into the processor design. Processor 1102 may be a self-contained system, containing multiple cores or processors, a bus, memory controller, cache, etc. A multi-core processor may be symmetric or asymmetric.

To enable user interaction with the computing-device architecture 1100, input device 1122 can represent any number of input mechanisms, such as a microphone for speech, a touch-sensitive screen for gesture or graphical input, keyboard, mouse, motion input, speech and so forth. Output device 1124 can also be one or more of a number of output mechanisms known to those of skill in the art, such as a display, projector, television, speaker device, etc. In some instances, multimodal computing devices can enable a user to provide multiple types of input to communicate with computing-device architecture 1100. Communication interface 1126 can generally govern and manage the user input and computing device output. There is no restriction on operating on any particular hardware arrangement and therefore the basic features here may easily be substituted for improved hardware or firmware arrangements as they are developed.

Storage device 1114 is a non-volatile memory and can be a hard disk or other types of computer readable media which can store data that are accessible by a computer, such as magnetic cassettes, flash memory cards, solid state memory devices, digital versatile disks, cartridges, random-access memories (RAMs) 1106, read only memory (ROM) 1108, and hybrids thereof. Storage device 1114 can include services 1116, 1118, and 1120 for controlling processor 1102. Other hardware or software modules are contemplated. Storage device 1114 can be connected to the computing device connection 1112. In one aspect, a hardware module that performs a particular function can include the software component stored in a computer-readable medium in connection with the necessary hardware components, such as processor 1102, connection 1112, output device 1124, and so forth, to carry out the function.

The term “substantially.” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C. or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Claim language or other language reciting “at least one processor configured to,” “at least one processor being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. An apparatus for processing data, the apparatus comprising: at least one memory; and at least one processor coupled to the at least one memory and configured to: obtain image data having a first resolution; downsample the image data to generate downsampled image data, wherein the downsampled image data has a second resolution that is lower than the first resolution; process the downsampled image data to generate processed downsampled image data; and generate, using a machine-learning model, upsampled image data based on the processed downsampled image data and the image data.

Aspect 2. The apparatus of aspect 1, wherein, to process the downsampled image data, the at least one processor is configured to at least one of: apply one or more filters to the downsampled image data; reduce noise in the downsampled image data; sharpen the downsampled image data; de-mosaic the downsampled image data; or re-mosaic the downsampled image data.

Aspect 3. The apparatus of any one of aspects 1 or 2, wherein the machine-learning model is trained to receive first image data having the first resolution and second image data having the second resolution as inputs and to generate third image data having the first resolution.

Aspect 4. The apparatus of any one of aspects 1 to 3, wherein the machine-learning model comprises a neural network comprising two or more convolutional layers.

Aspect 5. The apparatus of any one of aspects 1 to 4, wherein the upsampled image data has the first resolution.

Aspect 6. The apparatus of any one of aspects 1 to 5, wherein the image data comprises raw image data captured by an image sensor of a device and wherein the downsampled image data is processed by an image signal processor (ISP) of the device.

Aspect 7. The apparatus of any one of aspects 1 to 6, wherein the at least one processor is further configured to: rearrange the image data to generate rearranged image data; and provide the rearranged image data and the downsampled image data as inputs to the machine-learning model.

Aspect 8. The apparatus of aspect 7, wherein, to rearrange the image data, the at least one processor is configured to rearrange the image data as a tensor with dimensions related to dimensions of the downsampled image data.

Aspect 9. The apparatus of any one of aspects 1 to 8, wherein the at least one processor is further configured to at least one of display, store, or transmit the upsampled image data.

Aspect 10. The apparatus of any one of aspects 1 to 9, wherein, to downsample the image data, the at least one processor is configured to bin the image data.

Aspect 11. The apparatus of any one of aspects 1 to 10, wherein the image data comprises first image data, and wherein the at least one processor is further configured to: obtain second image data; and generate, processed second image data based on the upsampled image data and the second image data.

Aspect 12. The apparatus of aspect 11, wherein: the first image data comprises a first frame of video data; and the second image data comprises a second frame of the video data.

Aspect 13. The apparatus of any one of aspects 11 or 12, wherein the at least one processor is further configured to: obtain third image data; and process the third image data to generate processed third image data; wherein the processed second image data is generated further based on the processed third image data.

Aspect 14. The apparatus of any one of aspects 1 to 13, wherein the image data comprises first image data, and wherein the at least one processor is further configured to: obtain second image data having the first resolution; downsample the second image data to generate downsampled second image data, wherein the downsampled second image data has the second resolution; process the downsampled second image data to generate processed downsampled second image data; and generate, using the machine-learning model, upsampled second image data based on the processed downsampled second image data and the second image data.

Aspect 15. A method for processing data, the method comprising: obtaining image data having a first resolution; downsampling the image data to generate downsampled image data, wherein the downsampled image data has a second resolution that is lower than the first resolution; processing the downsampled image data to generate processed downsampled image data; and generating, using a machine-learning model, upsampled image data based on the processed downsampled image data and the image data.

Aspect 16. The method of aspect 15, wherein processing the downsampled image data comprises at least one of: applying one or more filters to the downsampled image data; reducing noise in the downsampled image data; sharpening the downsampled image data; de-mosaicing the downsampled image data; or re-mosaicing the downsampled image data.

Aspect 17. The method of any one of aspects 15 or 16, wherein the machine-learning model is trained to receive first image data having the first resolution and second image data having the second resolution as inputs and to generate third image data having the first resolution.

Aspect 18. The method of any one of aspects 15 to 17, wherein the machine-learning model comprises a neural network comprising two or more convolutional layers.

Aspect 19. The method of any one of aspects 15 to 18, wherein the upsampled image data has the first resolution.

Aspect 20. The method of any one of aspects 15 to 19, wherein the image data comprises raw image data captured by an image sensor of a device and wherein the downsampled image data is processed by an image signal processor (ISP) of the device.

Aspect 21. The method of any one of aspects 15 to 20, further comprising: rearranging the image data to generate rearranged image data; and providing the rearranged image data and the downsampled image data as inputs to the machine-learning model.

Aspect 22. The method of aspect 21, wherein rearranging the image data comprises rearranging the image data as a tensor with dimensions related to dimensions of the downsampled image data.

Aspect 23. The method of any one of aspects 15 to 22, further comprising at least one of displaying, storing, or transmitting the upsampled image data.

Aspect 24. The method of any one of aspects 15 to 23, wherein downsampling the image data comprises binning the image data.

Aspect 25. The method of any one of aspects 15 to 24, wherein the image data comprises first image data, and wherein the method further comprises: obtaining second image data; and generating, processed second image data based on the upsampled image data and the second image data.

Aspect 26. The method of aspect 25, wherein: the first image data comprises a first frame of video data; and the second image data comprises a second frame of the video data.

Aspect 27. The method of any one of aspects 25 or 26, further comprising: obtaining third image data; and processing the third image data to generate processed third image data; wherein the processed second image data is generated further based on the processed third image data.

Aspect 28. The method of any one of aspects 15 to 27, wherein the image data comprises first image data, and wherein the method further comprises: obtaining second image data having the first resolution; downsampling the second image data to generate downsampled second image data, wherein the downsampled second image data has the second resolution; processing the downsampled second image data to generate processed downsampled second image data; and generating, using the machine-learning model, upsampled second image data based on the processed downsampled second image data and the second image data.

Aspect 29. A non-transitory computer-readable storage medium having stored thereon instructions that, when executed by at least one processor, cause the at least one processor to: obtain image data having a first resolution; downsample the image data to generate downsampled image data, wherein the downsampled image data has a second resolution that is lower than the first resolution; process the downsampled image data to generate processed downsampled image data; and generate, using a machine-learning model, upsampled image data based on the processed downsampled image data and the image data.

Aspect 30. An apparatus for processing data, the apparatus comprising: means for obtaining image data having a first resolution; means for downsampling the image data to generate downsampled image data, wherein the downsampled image data has a second resolution that is lower than the first resolution; means for processing the downsampled image data to generate processed downsampled image data; and means for generating, using a machine-learning model, upsampled image data based on the processed downsampled image data and the image data.

Aspect 31. An apparatus for processing data, the apparatus comprising: at least one memory; and at least one processor coupled to the at least one memory and configured to: obtain first image data; process the first image data to generate processed first image data; obtain second image data; and generate, using a machine-learning model, processed second image data based on the processed first image data and the second image data.

Aspect 32. The apparatus of aspect 31, wherein the machine-learning model is trained to receive image data and first processed image data as inputs and to generate second processed image data.

Aspect 33. The apparatus of any one of aspects 31 or 32, wherein the machine-learning model comprises a neural network comprising two or more convolutional layers.

Aspect 34. The apparatus of any one of aspects 31 to 33, wherein: the first image data comprises a first frame of video data; and the second image data comprises a second frame of the video data.

Aspect 35. The apparatus of any one of aspects 31 to 34, wherein, to process the first image data, least one processor is configured to at least one of: apply one or more filters to the first image data; reduce noise in the first image data; sharpen the first image data; de-mosaic the first image data; or re-mosaic the first image data.

Aspect 36. The apparatus of any one of aspects 31 to 35, wherein the at least one processor is further configured to: obtain third image data; and process the third image data to generate processed third image data; wherein the processed second image data is generated further based on the processed third image data.

Aspect 37. The apparatus of any one of aspects 31 to 36, wherein: to process the first image data, the at least one processor is configured to: downsample the first image data to generate downsampled first image data; process the downsampled first image data to generate processed downsampled image data; and generate upsampled first image data based on the processed downsampled image data and the first image data; and the processed second image data is generated based on the upsampled first image data.

Aspect 38. A method for processing data, the method comprising: obtaining first image data; processing the first image data to generate processed first image data; obtaining second image data; and generating, using a machine-learning model, processed second image data based on the processed first image data and the second image data.

Aspect 39. The method of aspect 38, wherein the machine-learning model is trained to receive image data and first processed image data as inputs and to generate second processed image data.

Aspect 40. The method of any one of aspects 38 or 39, wherein the machine-learning model comprises a neural network comprising two or more convolutional layers.

Aspect 41. The method of any one of aspects 38 to 40, wherein: the first image data comprises a first frame of video data; and the second image data comprises a second frame of the video data.

Aspect 42. The method of any one of aspects 38 to 41, wherein processing the first image data comprises at least one of: applying one or more filters to the first image data; reducing noise in the first image data; sharpening the first image data; de-mosaicing the first image data; or re-mosaicing the first image data.

Aspect 43. The method of any one of aspects 38 to 42, further comprising: obtaining third image data; and processing the third image data to generate processed third image data; wherein the processed second image data is generated further based on the processed third image data.

Aspect 44. The method of any one of aspects 38 to 43, wherein: processing the first image data comprises: downsampling the first image data to generate downsampled first image data; processing the downsampled first image data to generate processed downsampled image data; and generating upsampled first image data based on the processed downsampled image data and the first image data; and the processed second image data is generated based on the upsampled first image data.

Aspect 45. A non-transitory computer-readable storage medium having stored thereon instructions that, when executed by at least one processor, cause the at least one processor to perform operations according to any of aspects 15 to 28.

Aspect 46. An apparatus for providing virtual content for display, the apparatus comprising one or more means for perform operations according to any of aspects 15 to 28.

Aspect 47. A non-transitory computer-readable storage medium having stored thereon instructions that, when executed by at least one processor, cause the at least one processor to perform operations according to any of aspects 38 to 44.

Aspect 48. An apparatus for providing virtual content for display, the apparatus comprising one or more means for perform operations according to any of aspects 38 to 44.

What is claimed is:

1. An apparatus for processing data, the apparatus comprising:
at least one memory; and
at least one processor coupled to the at least one memory and configured to:
obtain image data having a first resolution;
downsample the image data to generate downsampled image data, wherein the downsampled image data has a second resolution that is lower than the first resolution;
process the downsampled image data to generate processed downsampled image data; and
generate, using a machine-learning model, upsampled image data based on the processed downsampled image data and the image data.

2. The apparatus of claim 1, wherein, to process the downsampled image data, the at least one processor is configured to at least one of:
apply one or more filters to the downsampled image data;
reduce noise in the downsampled image data;
sharpen the downsampled image data;
de-mosaic the downsampled image data; or
re-mosaic the downsampled image data.

3. The apparatus of claim 1, wherein the machine-learning model is trained to receive first image data having the first resolution and second image data having the second resolution as inputs and to generate third image data having the first resolution.

4. The apparatus of claim 1, wherein the machine-learning model comprises a neural network comprising two or more convolutional layers.

5. The apparatus of claim 1, wherein the upsampled image data has the first resolution.

6. The apparatus of claim 1, wherein the image data comprises raw image data captured by an image sensor of a device and wherein the downsampled image data is processed by an image signal processor (ISP) of the device.

7. The apparatus of claim 1, wherein the at least one processor is further configured to:
rearrange the image data to generate rearranged image data; and
provide the rearranged image data and the downsampled image data as inputs to the machine-learning model.

8. The apparatus of claim 7, wherein, to rearrange the image data, the at least one processor is configured to rearrange the image data as a tensor with dimensions related to dimensions of the downsampled image data.

9. The apparatus of claim 1, wherein the at least one processor is further configured to at least one of display, store, or transmit the upsampled image data.

10. The apparatus of claim 1, wherein, to downsample the image data, the at least one processor is configured to bin the image data.

11. The apparatus of claim 1, wherein the image data comprises first image data, and wherein the at least one processor is further configured to:
obtain second image data; and
generate, processed second image data based on the upsampled image data and the second image data.

12. The apparatus of claim 11, wherein:
the first image data comprises a first frame of video data; and
the second image data comprises a second frame of the video data.

13. The apparatus of claim 11, wherein the at least one processor is further configured to:
obtain third image data; and
process the third image data to generate processed third image data;
wherein the processed second image data is generated further based on the processed third image data.

14. The apparatus of claim 1, wherein the image data comprises first image data, and wherein the at least one processor is further configured to:
obtain second image data having the first resolution;
downsample the second image data to generate downsampled second image data, wherein the downsampled second image data has the second resolution;
process the downsampled second image data to generate processed downsampled second image data; and
generate, using the machine-learning model, upsampled second image data based on the processed downsampled second image data and the second image data.

15. A method for processing data, the method comprising:
obtaining image data having a first resolution;
downsampling the image data to generate downsampled image data, wherein the downsampled image data has a second resolution that is lower than the first resolution;
processing the downsampled image data to generate processed downsampled image data; and
generating, using a machine-learning model, upsampled image data based on the processed downsampled image data and the image data.

16. The method of claim 15, wherein processing the downsampled image data comprises at least one of:
applying one or more filters to the downsampled image data;
reducing noise in the downsampled image data;
sharpening the downsampled image data;
de-mosaicing the downsampled image data; or
re-mosaicing the downsampled image data.

17. The method of claim 15, wherein the machine-learning model is trained to receive first image data having the first resolution and second image data having the second resolution as inputs and to generate third image data having the first resolution.

18. The method of claim 15, wherein the machine-learning model comprises a neural network comprising two or more convolutional layers.

19. The method of claim 15, wherein the upsampled image data has the first resolution.

20. The method of claim 15, wherein the image data comprises raw image data captured by an image sensor of a device and wherein the downsampled image data is processed by an image signal processor (ISP) of the device.

21. The method of claim 15, further comprising:
rearranging the image data to generate rearranged image data; and
providing the rearranged image data and the downsampled image data as inputs to the machine-learning model.

22. The method of claim 21, wherein rearranging the image data comprises rearranging the image data as a tensor with dimensions related to dimensions of the downsampled image data.

23. The method of claim 15, further comprising at least one of displaying, storing, or transmitting the upsampled image data.

24. The method of claim 15, wherein downsampling the image data comprises binning the image data.

25. The method of claim 15, wherein the image data comprises first image data, and wherein the method further comprises:
obtaining second image data; and
generating, processed second image data based on the upsampled image data and the second image data.

26. The method of claim 25, wherein:
the first image data comprises a first frame of video data; and
the second image data comprises a second frame of the video data.

27. The method of claim 25, further comprising:
obtaining third image data; and
processing the third image data to generate processed third image data;
wherein the processed second image data is generated further based on the processed third image data.

28. The method of claim 15, wherein the image data comprises first image data, and wherein the method further comprises:
obtaining second image data having the first resolution;
downsampling the second image data to generate downsampled second image data, wherein the downsampled second image data has the second resolution;
processing the downsampled second image data to generate processed downsampled second image data; and
generating, using the machine-learning model, upsampled second image data based on the processed downsampled second image data and the second image data.

29. A non-transitory computer-readable storage medium having stored thereon instructions that, when executed by at least one processor, cause the at least one processor to:
obtain image data having a first resolution;
downsample the image data to generate downsampled image data, wherein the downsampled image data has a second resolution that is lower than the first resolution;
process the downsampled image data to generate processed downsampled image data; and
generate, using a machine-learning model, upsampled image data based on the processed downsampled image data and the image data.

30. An apparatus for processing data, the apparatus comprising:
means for obtaining image data having a first resolution;
means for downsampling the image data to generate downsampled image data, wherein the downsampled image data has a second resolution that is lower than the first resolution;
means for processing the downsampled image data to generate processed downsampled image data; and
means for generating, using a machine-learning model, upsampled image data based on the processed downsampled image data and the image data.
